(19) United States
(12) Patent Application Publication
(10) Pub. No.: US 2007/0069987 A1
(43) Pub. Date: Mar. 29, 2007

(54) Plasma display apparatus and driving method thereof

(75) Inventors: Kirack Park, Chilgok-gun (KR); Jongwoon Bae, Gumi-si (KR); Seonghwan Ryu, Gumi-si (KR); Yoonjoo Cho, Seoul (KR); Dooyong Hwang, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/292,148

(22) Filed: Dec. 2, 2005

(30) Foreign Application Priority Data
Sep. 26, 2005 (KR) 10-2005-0089566

(51) Int. Cl. G09G 3/28

(52) U.S. Cl. 345/67

(57) ABSTRACT

There is provided a plasma display apparatus which scans the scan electrodes (Y) with at least one scan type among a plurality of scan types and a driving method thereof. Therefore, it is possible to prevent an excessive displacement current and thus protecting a data driver integrated circuit from electrical damage, by scanning the scan electrodes (Y) with at least one scan type among the plurality of scan types. The plasma display apparatus comprises a plurality of scan electrodes; a plurality of sustain electrodes formed in parallel to the scan electrodes; data electrodes intersecting the scan electrodes and the sustain electrodes; a scan driver scanning scan electrodes with one scan type among a plurality of scan types having different scan orders which scan the plurality of scan electrodes in an address period; a data driver supplying data to the data electrodes corresponding to the one scan type; and a sustain driver supplying a first sustain bios voltage that is less than a second sustain bios voltage supplied to the sustain electrodes in the address period from a setdown period of a reset period before the address period to a period before a first scan pulse is supplied to the scan electrodes.

This Nonprovisional application claims priority under 35 U.S.C. §119(a) on Patent Application No. 10-2005-0089566 filed in Korea on Sep. 26, 2005 the entire contents of which are hereby incorporated by reference.

### BACKGROUND OF THE INVENTION

1. Field of the Invention

The present invention relates to a plasma display apparatus, and more particularly, to a plasma display apparatus which scans the scan electrodes in one or more scan type among a plurality of scan types and a driving method thereof.

2. Description of the Background Art

In a conventional plasma display panel, one cell is formed by barrier ribs formed between a front panel and a rear panel and main discharge gas such as Neon (Ne), Helium (He), or mixed gas (Ne+He) of Neon and Helium and inert gas containing Xenon (Xe) of small quantity are filled within each cell. A plurality of cells constitutes one pixel. For example, a red color (R) cell, a green color (G) cell and a blue color (B) cell constitute one pixel.

When this plasma display panel is discharged by a high frequency voltage, the inert gas generates vacuum ultraviolet rays and allows a phosphor formed between barrier ribs to emit light, and thus an image is embodied. A plasma display panel can be manufactured to be thin and light weight, Such a plasma display panel has been considered as one of the next generation display devices.

In this plasma display panel, a plurality of electrodes, for example, a scan electrode (Y), a sustain electrode (Z), a data electrode (X) are formed, and a discharge occurs by supplying a predetermined driving voltage to the plurality of electrodes, and thus an image is displayed. A driver integrated circuit is connected to the electrodes to supply a driving voltage to the electrodes of the plasma display panel.

For example, a data driver integrated circuit is connected to the data electrode (X) among the electrodes of the plasma display panel and a scan driver integrated circuit is connected to the scan electrode (Y).

When the plasma display panel is driven, a displacement current (Id) flows in the driver integrated circuit and the displacement current is changed by various factors.

For example, a displacement current flowing to the data driver integrated circuit fluctuates depending on an equivalent capacitance C of the plasma display panel and the number of times the data driver integrated circuit switched. Specifically, a displacement current flowing to the data driver integrated circuit increases with increase of an equivalent capacitance C of the plasma display panel and the number of times the data driver integrated circuit switched.

On the other hand, the equivalent capacitance (C) of the plasma display panel is determined by the equivalent capacitances (C) between electrodes and it is described with reference to the attached FIG. 1.

FIG. 1 is a diagram illustrating the equivalent capacitance (C) of the plasma display panel.

Referring to FIG. 1, the equivalent capacitance (C) of the plasma display panel comprises an equivalent capacitance (Cm1) between data electrodes, for example, between a X1 data electrode and a X2 data electrode, an equivalent capacitance (Cm2) between the data electrode and the scan electrode, for example, between the X1 data electrode and a Y1 scan electrode, and an equivalent capacitance (Cm2) between the data electrode and a sustain electrode, for example, between the X1 data electrode and a Z1 sustain electrode.

Since a voltage applied to the scan electrode (Y) or the data electrode (X) changes with an operation of the switching elements included in a driver integrated circuit, for example, a scan driver integrated circuit for driving the scan electrode (Y) by supplying scan pulses to the scan electrode (Y) in the address period and a driver integrated circuit, for example, a data driver integrated circuit for driving the data electrode (X) by supplying data pulses to the data electrode (X) in the address period, a displacement current Id generated by the Cm1 equivalent capacitance and the Cm2 equivalent capacitance flows to the data integrated circuit through the data electrode (X).

As described above, if the equivalent capacitance of the plasma display panel increases, the displacement current (Id) flowing to the data driver integrated circuit increases and if the number of times the data driver integrated circuit switched increases, the displacement current (Id) increases. The number of times the data driver integrated circuit switched changes depending on inputted image data.

When the image data is in a specific pattern in which logic values 1 and 0 repeat, the displacement current flowing to the data driver integrated circuit increases too much, so that there is a problem in that electrical damage such as a burned-out data driver integrated circuit will occur.

### SUMMARY OF THE INVENTION

Accordingly, an object of the present invention is to solve at least the problems and disadvantages of the background art.

An object of the present invention is to provide a plasma display apparatus which can be operated with a plurality of scan types and prevent electrical damage to a driver integrated circuit by performing scanning with at least scan type selected among the plurality of scan types and a driving method thereof.

According to an aspect of the present invention, there is provided a plasma display apparatus comprising: a plurality of scan electrodes; a plurality of sustain electrodes formed in parallel to the scan electrodes; data electrodes intersecting the scan electrodes and the sustain electrodes; a scan driver scanning the scan electrodes with one scan type among a plurality of scan types having a different scan order which scan the plurality of scan electrodes in an address period; a data driver supplying data to the data electrodes corresponding to the one scan type; and a sustain driver supplying a first sustain bios voltage that is less than a second sustain bios voltage supplied to the sustain electrodes in the address period from a setdown period of a reset period before the address period to a period before a first scan pulse is supplied to the scan electrodes.

According to another aspect of the present invention, there is provided a plasma display apparatus comprising: a plasma display panel in which a plurality of scan electrodes and sustain electrodes, and data electrodes intersecting the scan electrodes and the sustain electrodes are formed; a scan driver scanning the scan electrodes by allowing a scan order of the plurality of scan electrodes to be different from the scan order of the first data pattern in a second data pattern different from a first data pattern among data patterns of inputted image data; a data driver supplying a data pulse to the data electrodes corresponding to the scan order of the plurality of scan electrodes; and a sustain driver supplying a first sustain bios voltage that is less than a second sustain bios voltage supplied to the sustain electrodes in an address period from a setdown period of a reset period before the address period to a period before a first scan pulse is supplied to the scan electrodes.

According to still another aspect of the present invention, there is provided a method of driving a plasma display apparatus comprising scan electrodes, sustain electrodes, and data electrodes formed in a direction intersecting the scan electrodes and the sustain electrodes, the method comprising: scanning the scan electrodes with one scan type among a plurality of scan types scanning the plurality of scan electrodes in a different scan order in an address period; supplying data to the data electrodes corresponding to the one scan type; and supplying a first sustain bios voltage that is less than a second sustain bios voltage supplied to the sustain electrodes in the address period from a setdown period of a reset period before the address period to a period before a first scan pulse is supplied to the scan electrodes.

According to still another aspect of the present invention, there is provided a method of driving a plasma display apparatus comprising a plurality of scan electrodes and sustain electrodes, and data electrodes formed in a direction intersecting the scan electrodes and the sustain electrodes, the method comprising: scanning the scan electrodes by allowing a scan order of the plurality of scan electrodes to be different from the scan order of the first data pattern in a second data pattern different from a first data pattern among data patterns of inputted image data; supplying data pulses to the data electrodes corresponding to the scan order of the plurality of scan electrodes; and supplying a first sustain bios voltage that is less than a second sustain bios voltage supplied to the sustain electrodes in an address period from a setdown period of a reset period before the address period to a period before a first scan pulse is supplied to the scan electrodes.

As described in detail above, according to a plasma display apparatus and a drive method of the present invention, it is possible to prevent an excessive displacement current from occurring by scanning the scan electrodes (Y) with any one among the plurality of scan types and thus prevent electrical damage to a driver integrated circuit.

According to the present invention, it is also possible to stabilize an address discharge and thus drive in a high speed, by controlling a magnitude of a voltage supplied to the sustain electrode (Z) before a first scan pulse is supplied to the scan electrode (Y) after a setup period.

### BRIEF DESCRIPTION OF THE DRAWINGS

The invention will be described in detail with reference to the following drawings in which like numerals refer to like elements.

FIG. 1 is a diagram illustrating an equivalent capacitance (C) of a plasma display panel;

FIG. 2 is a diagram illustrating a plasma display apparatus according to the present invention;

FIG. 3 is a diagram illustrating an example of a structure of the plasma display panel according to the present invention;

FIG. 4 is a diagram illustrating a method of embodying a gray level of an image in the plasma display apparatus according to the present invention;

FIGS. 5a to 5d are diagrams illustrating a method of driving the plasma display apparatus according to the present invention;

FIG. 6 is a diagram illustrating an embodiment in which a first sustain bias voltage (Vzb1) is supplied only in a predetermined subfield within one frame;

FIG. 7 is a diagram illustrating a magnitude of a displacement current depending on inputted image data;

FIGS. 8a and 8b are diagrams illustrating an embodiment of a method of changing a scan order by considering image data and a displacement current depending on the image data;

FIG. 9 is a diagram illustrating another embodiment in a method of driving the plasma display apparatus according to the present invention;

FIG. 10 is a diagram illustrating in detail a construction and an operation of a scan driver for embodying a method of driving the plasma display apparatus according to the present invention;

FIG. 11 is a diagram illustrating a configuration of a basic circuit block included in a data comparing unit 1000 included in the scan driver of the plasma display apparatus according to the present invention;

FIG. 12 is a diagram illustrating in detail an operation of a first judging unit to a third judging unit of the data comparing unit;

FIG. 13 is a diagram illustrating pattern contents of image data depending on output signals of the first judging unit to the third judging unit (734-1, 734-2, 734-3) included in the basic circuit block of the data comparing unit of the present invention;

FIG. 14 is a block diagram of the data comparing unit 1000 and a scan order determining unit 1001 of the scan driver in the plasma display apparatus according to the present invention;

FIG. 15 is a diagram illustrating pattern contents of image data depending on output signals of a first to third judging units (XOR1, XOR2, XOR3) included in the data comparing unit of the present invention;

FIG. 16 is a diagram illustrating another configuration of a basic circuit block included in the data comparing unit 1000 included in the scan driver of the plasma display apparatus according to the present invention;

FIG. 17 is a diagram illustrating pattern contents of image data depending on output signals of the first to ninth judging units (XOR1 to XOR9) included in the circuit blocks shown in FIG. 16 of the present invention;

FIG. 18 is a block diagram of the data comparing unit 1000 and the scan order determining unit 1001 of the scan driver in the plasma display apparatus according to the present invention referring to the FIGS. 16 and 17;

FIG. 19 is a block diagram of an embodiment in which the data comparing unit and the scan order determining unit according to the present invention are applied to each subfield;

FIG. 20 is a diagram illustrating an embodiment of a method of selecting a subfield which scans the scan electrodes (Y) with any one scan type among a plurality of scan types within one frame;

FIG. 21 is a diagram illustrating the fact that a scan order may be different in patterns of two different image data;

FIG. 22 is a diagram illustrating an embodiment of a method of adjusting a scan order by setting a critical value depending on an image data pattern; and

FIG. 23 is a diagram illustrating an embodiment of a method of determining a scan order corresponding to a scan electrode group including a plurality of scan electrodes (Y).

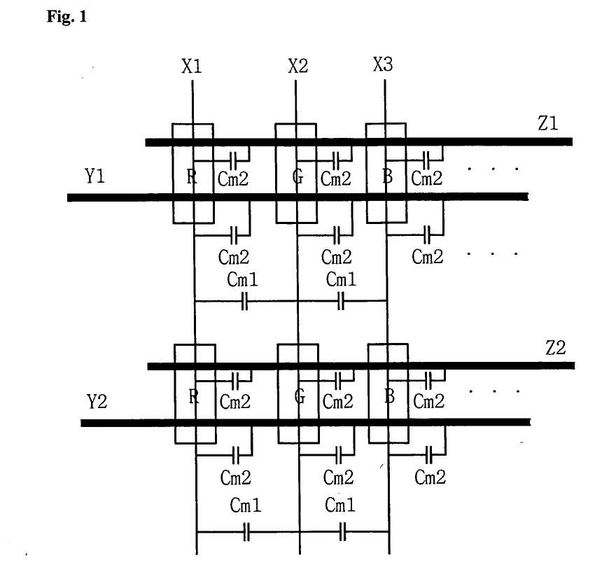

### DETAILED DESCRIPTION OF PREFERRED EMBODIMENTS

Preferred embodiments of the present invention will be described in a more detailed manner with reference to the drawings.

According to an aspect of the present invention, there is provided a plasma display apparatus comprising: a plurality of scan electrodes; a plurality of sustain electrodes formed in parallel to the scan electrodes; data electrodes intersecting the scan electrodes and the sustain electrodes; a scan driver scanning the scan electrodes with one scan type among a plurality of scan types having different scan orders which scan the plurality of scan electrodes in an address period; a data driver supplying data to the data electrodes corresponding to the one scan type; and a sustain driver supplying a first sustain bios voltage that is less than a second sustain bios voltage supplied to the sustain electrodes in the address period from a setdown period of a reset period before the address period to a period before a first scan pulse is supplied to the scan electrodes.

The scan driver may calculate a displacement current corresponding to each of a plurality of scan types depending on inputted image data and scan the scan electrodes with a scan type having the lowest displacement current among the plurality of scan types.

The scan electrode may comprise the first and the second scan electrodes separated by a predetermined number depending on the scan type, the data electrode may comprise the first and second data electrodes, and when the scan driver comprises a first and a second discharge cell disposed at the intersections of the first scan electrode and the first and second data electrodes and a third and fourth discharge cells disposed at the intersections of the second scan electrode and the first and the second data electrodes, the scan driver may calculate the displacement current for the first discharge cell by comparing the data of the first to the fourth discharge cells.

The scan driver may obtain a first result in which data of the first discharge cell and data of the second discharge cell are compared, a second result in which data of the first discharge cell and data of the third discharge cell are compared, and a third result in which data of the third discharge cell and data of the fourth discharge cell are compared, determine a calculating equation of the displacement current depending on a combination of the first to third results, and calculate a total displacement current of the first discharge cell by totaling the displacement currents calculated using the determined calculating equation.

If a capacitance between adjacent data electrodes is Cm1, a capacitance between the data electrode and the scan electrode and a capacitance between the data electrode and the sustain electrode are Cm2, the scan driver may calculate the displacement current depending on a combination of the first to the third results based on Cm1 and Cm2.

The scan driver may calculate a displacement current for the plurality of scan types in each subfield of one frame and scan the scan electrode with a scan type in which the displacement current becomes the lowest in each subfield.

The scan type may comprise a first scan type which divides the scan electrodes into a plurality of group and scans the divided scan electrodes, when a scan type in which the displacement current becomes the lowest is the first scan type, the scan driver may continuously scan the scan electrodes belonging to the same group with the first scan type.

The scan driver may calculate a displacement current corresponding to each of the plurality of scan types depending on inputted image data and scan the scan electrodes with at least one scan type among scan types in which the displacement current is a preset critical displacement current or less among the plurality of scan types.

The first sustain bias voltage may be a ground level voltage (GND).

The second sustain bias voltage may be less than or equal to the sustain voltage (Vs) supplied to the scan electrode or the sustain electrode in a sustain period after the address period.

The sustain driver may supply the first sustain bias voltage to the sustain electrode during a setdown period of the reset period.

The sustain driver may supply a first sustain bios voltage that is less than a second sustain bios voltage supplied to the sustain electrodes in the address period of a predetermined subfield among subfields of one frame from a setdown period of the reset period before the address period to a period before a first scan pulse is supplied to the scan electrodes.

The sustain driver may supply a rising waveform in which a voltage gradually rises from the first sustain bias voltage to the second sustain bias voltage to the sustain electrode after the first sustain bias voltage is supplied.

A rising slope of a voltage of the rising waveform from the first sustain bias voltage to the second sustain bias voltage may be smoother than a rising slope of a rising voltage of sustain pulses supplied to the scan electrodes or the sustain electrodes in a sustain period after the address period.

According to another aspect of the present invention, there is provided a plasma display apparatus comprising: a plasma display panel in which a plurality of scan electrodes and sustain electrodes and data electrodes intersecting the scan electrodes and the sustain electrodes are formed; a scan driver scanning the scan electrodes by allowing a scan order of the plurality of scan electrodes to be different from the scan order of the first data pattern in a second data pattern different from a first data pattern among data patterns of inputted image data; a data driver supplying a data pulse to the data electrodes corresponding to the scan order of the plurality of scan electrodes; and a sustain driver supplying a first sustain bios voltage that is less than a second sustain bios voltage supplied to the sustain electrodes in an address period from a setdown period of a reset period before the address period to a period before a first scan pulse is supplied to the scan electrodes.

A first data pattern or a second data pattern may allow a load value depending on pattern of data to be a preset critical load value or more.

A load value depending on pattern of data may be obtained by the sum of a load value of a horizontal direction and that of a vertical direction of a corresponding data pattern.

The first data pattern or the second data pattern may allow a magnitude of a displacement current depending on a pattern of data to be a preset critical current value or more.

According to still another aspect of the present invention, there is provided a method of driving a plasma display apparatus comprising scan electrodes, sustain electrodes, and data electrodes formed in a direction intersecting the scan electrodes and the sustain electrodes, the method comprising: scanning the scan electrodes with one scan type among a plurality of scan types scanning the plurality of scan electrodes in a different scan order in an address period; supplying data to the data electrodes corresponding to the one scan type; and supplying a first sustain bios voltage that is less than a second sustain bios voltage supplied to the sustain electrodes in the address period from a setdown period of a reset period before the address period to a period before a first scan pulse is supplied to the scan electrodes.

According to still another aspect of the present invention, there is provided a method of driving a plasma display apparatus comprising a plurality of scan electrodes and sustain electrodes, and data electrodes formed in a direction intersecting the scan electrodes and the sustain electrodes, the method comprising: scanning the scan electrodes by allowing a scan order of the plurality of scan electrodes to be different from the scan order of the first data pattern in a second data pattern different from a first data pattern among data patterns of inputted image data; supplying data pulses to the data electrodes corresponding to the scan order of the plurality of scan electrodes; and supplying a first sustain bios voltage that is less than a second sustain bios voltage supplied to the sustain electrodes in an address period from a setdown period of a reset period before the address period to a period before a first scan pulse is supplied to the scan electrodes.

Hereinafter, a plasma display apparatus and a driving method thereof according to the present invention will be described in detail with reference to the accompanying drawings.

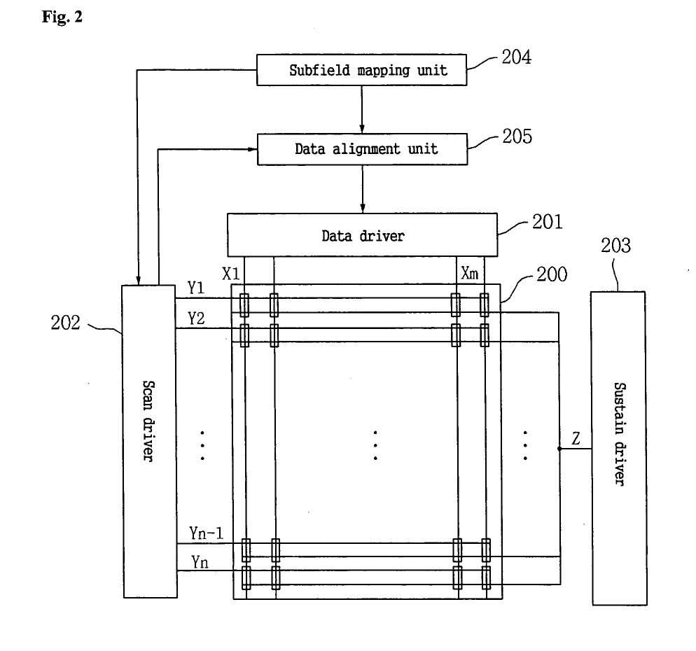

FIG. 2 is a diagram illustrating a plasma display apparatus according to the present invention.

Referring to FIG. 2, the plasma display apparatus according to the present invention comprises a plasma display panel 200, a data driver 201, a scan driver 202, a sustain driver 203, a subfield mapping unit 204, and a data arranging unit 205.

In the plasma display panel 200, a front panel (not shown) and a rear panel (not shown) are coupled to each other with a fixed interval separating the panels and a plurality of electrodes, for example, a scan electrode (Y) and a sustain electrode (Z) parallel to the scan electrode (Y) are formed and a data electrode (X) is formed to intersect the scan electrode (Y) and the sustain electrode (Z).

The scan driver 202 supplies a ramp-up waveform and a ramp-down waveform to the scan electrode (Y) during a reset period. The scan driver (202) also supplies sustain pulses (SUS) to the scan electrode (Y) during a sustain period. Specifically, the scan driver (202) scans the scan electrode (Y) with one scan type among a plurality of scan types having different scan orders which scan a plurality of scan electrodes (Y) during the address period. That is, the scan driver (202) supplies scan pulses (Sp) of a negative polarity scan voltage (−Vy) to the scan electrode (Y) during the address period with one scan type among the plurality of scan types.

During the sustain period, the sustain driver 203 supplies sustain pulses (SUS) to the sustain electrode (Z) by alternately operating with the scan driver 202 and during the address period, the sustain driver 203 supplies a first sustain bias voltage (Vzb1) that is less than a second sustain bias voltage (Vzb2) supplied to the sustain electrode (Z) from a setdown period of a reset period before the address period to a period before the first scan pulse is supplied to the scan electrode (Y).

The subfield mapping unit 204 outputs by subfield-mapping image data supplied from the outside, for example, a half-tone correcting unit.

The data arranging unit 205 rearranges the data which is subfield-mapped by the subfield mapping unit 204 to correspond to each data electrode (X) of the plasma display panel 200.

The data driver 201 samples and latches data which are rearranged by the data arranging unit 205 by means of the control of a timing controller which is not shown and then supplies the data to the data electrode (X). Specifically, the data driver 201 supplies data to the data electrode (X) depending on a scan type in which the scan driver 202 scans the scan electrodes (Y).

A function, an operation, a characteristic of elements of the plasma display apparatus according to the present invention, operation will be clear through the following descriptions on a method of driving the plasma display apparatus.

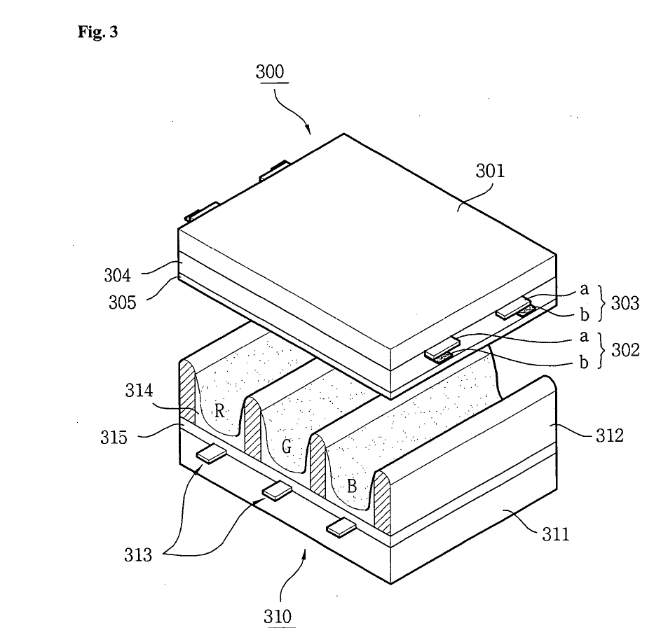

An example of a plasma display panel 200 that is one of elements of the plasma display apparatus according to the present invention will be described in detail with reference to FIG. 3.

FIG. 3 is a diagram illustrating an example of a structure of the plasma display panel according to the present invention.

Referring to FIG. 3, in the plasma display panel, a front panel 300 in which a plurality of sustain electrodes formed by a pair of a scan electrode (302, Y) and a sustain electrode (303, Z) are disposed in a front substrate 301 that is a display surface in which an image is displayed is arranged and a rear panel 310 in which a plurality of data electrodes (313, X) are disposed to intersect a plurality of sustain electrodes on a rear substrate 311 forming a rear surface are coupled to each other in parallel with a fixed distance separating the panels.

The front panel 300 comprises a pair of the scan electrode (302, Y) and the sustain electrode (303, Z) which discharge to each other in one discharge cell and sustains light emission of a discharge cell, that is, the scan electrode (302, Y) and the sustain electrode (303, Z) provided with a transparent electrode (a) made of transparent ITO materials and a bus electrode (b) made of metal. The scan electrode (302, Y) and the sustain electrode (303, Z) limits a discharge current from flowing and are covered with one or more upper dielectric layer 304 for isolating between electrode pairs, and a protective layer 305 which is evaporated with a magnesium oxide (MgO) is formed on a top surface of the upper dielectric layer 304 to facilitate a discharge condition.

In the rear panel 310, a plurality of discharge spaces, that is, stripe type (or well type) barrier ribs 312 for forming a discharge cell are disposed in parallel. A plurality of data electrodes (313, X) generating vacuum ultraviolet rays by performing an address discharge are disposed in parallel to the barrier ribs 312. RGB phosphors 314 emitting visible rays for displaying an image upon the address discharge are coated on an upper side surface of the rear panel 310. A lower dielectric layer 315 for protecting the data electrode (313, X) is formed between the data electrode (313, X) and the phosphor (314).

In FIG. 3, only an example of a structure of a plasma display panel that is one among driving elements of the plasma display apparatus according to the present invention is shown, but the present invention is not limited to the structure of FIG. 3. For example, in FIG. 3, the scan electrode (302, Y) and the sustain electrode (303, Z) are formed in the front panel 300 and the data electrode (313, X) is formed in the rear panel 310, but all of the scan electrode (302, Y), the sustain electrode (303, Z), and the data electrode (313, X) may be formed in the front panel 300.

In FIG. 3, it is shown that the scan electrode (302, Y) and the sustain electrode (303, Z) are manufactured of the transparent electrode (a) and the bus electrode (b), respectively, but the scan electrode (302, Y) and the sustain electrode (303, Z) may be manufactured of only the bus electrode (b).

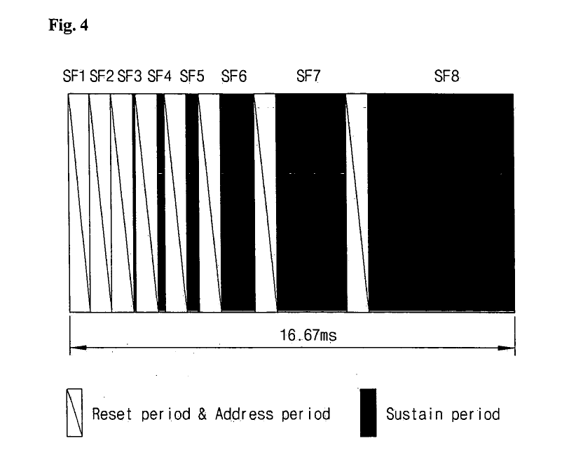

The plasma display apparatus according to the present invention comprising the plasma display panel embodies gray levels of various images by a frame divided into a plurality of subfields. A method of embodying the gray level in the plasma display apparatus according to the present invention will be described with reference to the attached FIG. 4.

FIG. 4 is a diagram illustrating a method of embodying a gray level of an image in the plasma display apparatus according to the present invention.

Referring to FIG. 4, the method of embodying a gray level of an image in the plasma display apparatus according to the present invention comprises dividing one frame into several subfields having the different number of light emissions and sub-dividing each subfield into a reset period (RPD) for initializing all discharge cells, an address period (APD) for selecting discharge cells to be discharged, and a sustain period (SPD) for embodying the gray level depending on the number of the discharge.

For example, when an image is intended to display with 256 gray levels, a frame period (16.67 ms) corresponding to 1/60 second is divided into, for example, 8 subfields (SF1 to SF8) as in FIG. 4 and each of 8 subfields (SF1 to SF8) is again sub-divided into a reset period, an address period and a sustain period.

The reset period and the address period in each subfield are the same in each subfield.

An address discharge for selecting a discharge cell to be discharged occurs by the voltage difference between the data electrode (X) and the scan electrode (Y).

The sustain period is a period for determining a gray level weight in each subfield. For example, if the gray level weights of the first subfield and the second subfield are set to 2⁰ and 2¹, respectively, a gray level weight of each subfield can be determined so that the gray level weight of each subfield increases in a ratio of 2ⁿ (n=0, 1, 2, 3, 4, 5, 6, 7). By controlling the number of sustain pulses supplied in the sustain period of each subfield depending on a gray level weight in the sustain period in each subfield, the gray levels of various images are embodied.

In FIG. 4, only a case where one frame is made of 8 subfields is shown, but the number of subfields constituting one frame can vary. For example, one frame may comprise 12 subfields from the first subfield to the twelfth subfield or 10 subfields from the first subfield to the tenth subfield.

In FIG. 4, subfields are disposed in the order in which a gray level weight increases in one frame, but subfields may be disposed in the order in which a gray level weight decreases in one frame or regardless of the gray level weight.

A detailed function and operation of the plasma display apparatus according to the present invention embodying the gray level of an image by such a method will be clear through the following descriptions on a method of driving the plasma display apparatus.

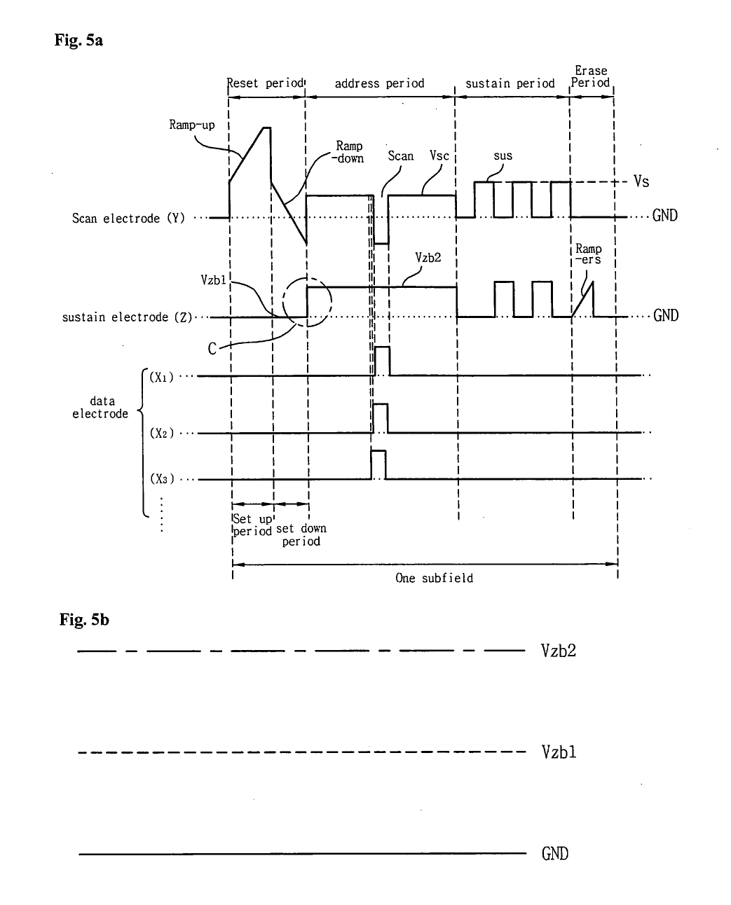

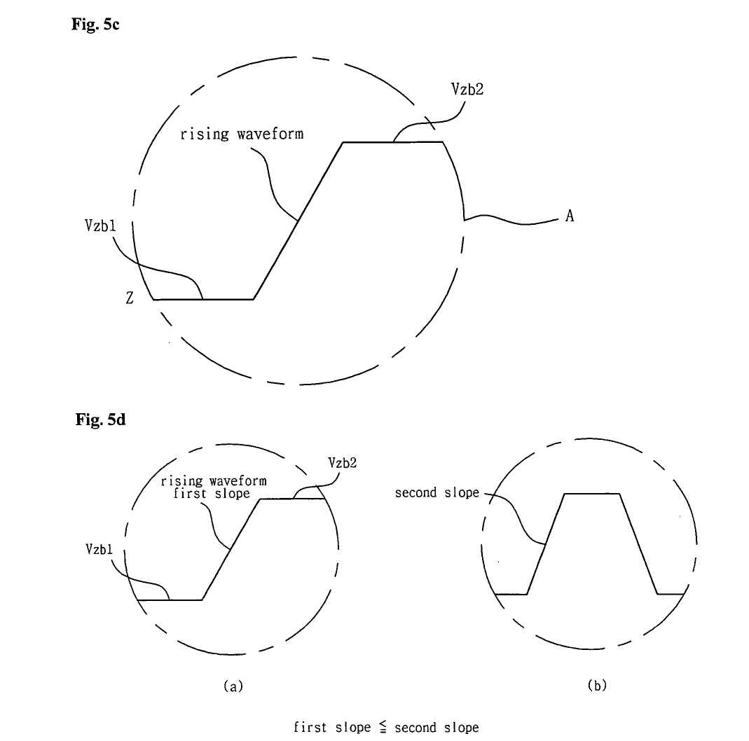

The method of driving the plasma display apparatus according to the present invention will be described with reference to the attached FIGS. 5a to 5d.

FIGS. 5a to 5d are diagrams illustrating a method of driving the plasma display apparatus according to the present invention.

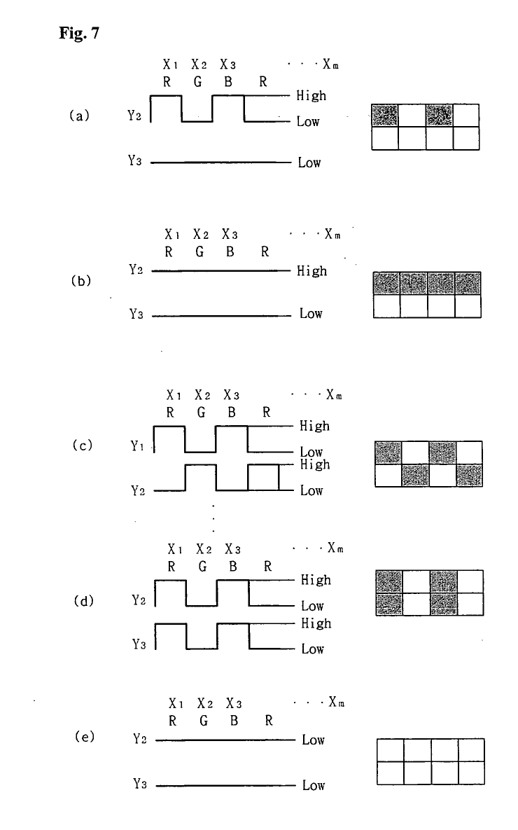

The drive method of the plasma display apparatus according to the present invention comprises scanning scan electrodes with one scan type among a plurality of scan types having different scan orders which scan the plurality of scan electrodes in an address period and supplying a first sustain bios voltage (Vzb1) that is less than a second sustain bios voltage supplied to the sustain electrodes (Z) in the address period from a setdown period of a reset period before the address period to a period before a first scan pulse is supplied to the scan electrodes (Y). After describing in detail a process of supplying the first sustain bios voltage (Vzb1) that is less than a second sustain bios voltage (Vzb2) supplied to the sustain electrodes (Z) in the address period from the setdown period of the reset period before the address period to a period before a first scan pulse is supplied to the scan electrodes (Y), a process of scanning the scan electrodes (Y) with one scan type among the plurality of scan types will be described in descriptions after FIG. 7.

Referring to FIG. 5a, the plasma display apparatus according to the present invention is driven by a driving waveform which is divided into a reset period, an address period, and a sustain period, as in FIG. 4. An erasing period for erasing some of the wall charges that are excessively formed within a discharge cell may be further included in the above periods.

In a setup period of the reset period, a ramp-up waveform is applied to the scan electrode (Y). A weak dark discharge occurs within a discharge cell of an entire screen due to the ramp-up waveform. Wall charges of a positive polarity are stacked on the data electrode (X) and the sustain electrode (Z) by the setup discharge and the wall charges of negative polarity are stacked on the scan electrode (Y).

In the setdown period, after ramp-up waveforms are supplied to the scan electrode (Y), ramp-down waveforms falling from a positive polarity voltage lower than a peak voltage of the ramp-up waveform to a specific voltage level lower than a voltage of ground (GND) level cause a small erasing discharge within the discharge cell, whereby wall charges excessively formed within the discharge cell are fully erased. During the setdown discharge, a number of wall charges sufficient to cause a stable address discharge remain evenly within the discharge cell.

In the address period, scan pulses of a negative polarity falling from a scan reference voltage (Vsc) are applied to the scan electrode (Y) and are synchronized with the scan pulses and thus data pulses of a positive polarity are applied to the address electrode (X). As a wall voltage generated in the reset period is added to the voltage difference between the scan pulses and the data pulses, an address discharge occurs within the discharge cell where the data pulse is applied. When a sustain voltage (Vs) is applied within the selected discharge cell by the address discharge, a number wall charges sufficient to cause the discharge are formed.

In the setdown period and the address period, a bias voltage of the positive polarity is supplied to the sustain electrode (Z) to prevent a mis-discharge with the scan electrode (Y) from occurring by decreasing the voltage difference with the scan electrode (Y). Preferably, a first sustain bios voltage (Vzb1) that is less than a second sustain bios voltage (Vzb2) supplied to the sustain electrodes (Z) in the address period is supplied to the sustain electrodes (Z) from a setdown period of the reset period before the address period to a period before a first scan pulse is supplied to the scan electrodes.

The reason why the first sustain bias voltage (Vzb1) is supplied to the sustain electrode (Z) before the first scan pulse is supplied to the scan electrode (Y) is to secure a sufficient amount of wall charges participating in address discharge upon address discharge by preventing wall charges within the discharge cell from being excessively erased in the setdown period. When setdown pulses in which a voltage gradually falls are supplied to the scan electrode (Y) in the setdown period, the reason is to stabilize a voltage of the sustain electrode (Z) by allowing a voltage of the sustain electrode (Z) to maintain the first sustain bias voltage (Vzb1) to a voltage level that is less than the second sustain bias voltage (Vzb2).

By securing a sufficient amount of wall charges participating in a discharge upon address discharge and stabilizing a voltage upon setdown, it is possible to scan at a high speed and thus drive the plasma display apparatus at a high speed.

In the sustain period, sustain pulses (Sus) are alternatively applied to the scan electrode (Y) and/or the sustain electrode (Z). As the sustain pulses and a wall voltage within the discharge cell are added together in the selected discharge cell by the address discharge, whenever each sustain pulse is applied, sustain discharge, that is, a display discharge occurs between the scan electrode (Y) and the sustain electrode (Z).

In an erasing period after the sustain discharge is completed, a voltage of a ramp-ers waveform having a narrow pulse width and low voltage level is supplied to the sustain electrode (Z) and thus erases all of the wall charges remaining within a discharge cell of an entire screen.

In FIG. 5b, the relationship of the first sustain bias voltage (Vzb1) and the second sustain bias voltage (Vzb2) is shown. The first sustain bias voltage (Vzb1) is less than the second sustain bias voltage (Vzb2) and is equal to or more than a ground level voltage (GND). Preferably, the first sustain bias voltage (Vzb1) is a ground level voltage (GND).

It is preferable that the first sustain bias voltage (Vzb1) is supplied to the sustain electrode (Z) during the setdown period of the reset period.

It is also preferable that the second sustain bias voltage (Vzb2) is less than or equal to the sustain voltage (Vs) supplied to the scan electrode (Y) or the sustain electrode (Z) in the sustain period after the address period.

In FIG. 5a, a voltage rapidly rising from the first sustain bias voltage (Vzb1) to the second sustain bias voltage (Vzb2) is shown. However it is preferable that a voltage gradually rises from the first sustain bias voltage (Vzb1) to the second sustain bias voltage (Vzb2) as shown in FIG. 5c.

Referring to FIG. 5c, after the first sustain bias voltage (Vzb1) is supplied to the sustain electrode (Z), a rising waveform in which a voltage gradually rises from the first sustain bias voltage (Vzb1) to the second sustain bias voltage (Vzb2) is supplied to the sustain electrode (Z). That is, a voltage supplied to the sustain electrode (Z) gradually rises after the first sustain bias voltage (Vzb1) and reaches the second sustain bias voltage (Vzb2).

After the first sustain bias voltage (Vzb1) is supplied, if a rising waveform in which a voltage gradually rises from the first sustain bias voltage (Vzb1) to the second sustain bias voltage (Vzb2) is supplied to the sustain electrode (Z), noise is relatively reduced in a driving waveform supplied to the scan electrode (Y), compared to a conventional case. The reason why noise decreases is that as an instantaneous voltage change rate decreases by a rising waveform in which a voltage gradually rises, an effect of a coupling through a capacitance of a panel decreases. If the generation of noise decreases, unstable driving is prevented from occurring upon driving of the plasma display panel.

It is preferable that a slope of the rising waveform is set to be smoother than the slope of the sustain pulse. The comparison of the slope of the rising waveform and the slope of the sustain pulse is shown in FIG. 5d.

Referring to FIG. 5d, a slope, that is, a first slope (a) in which that a voltage of the rising waveform rises from the first sustain bias voltage (Vzb1) to the second sustain bias voltage (Vzb2) is smoother than a slope, that is, a second slope (b) upon voltage rise of sustain pulses supplied to the scan electrode (Y) or the sustain electrode (Z) in the sustain period after the address period.

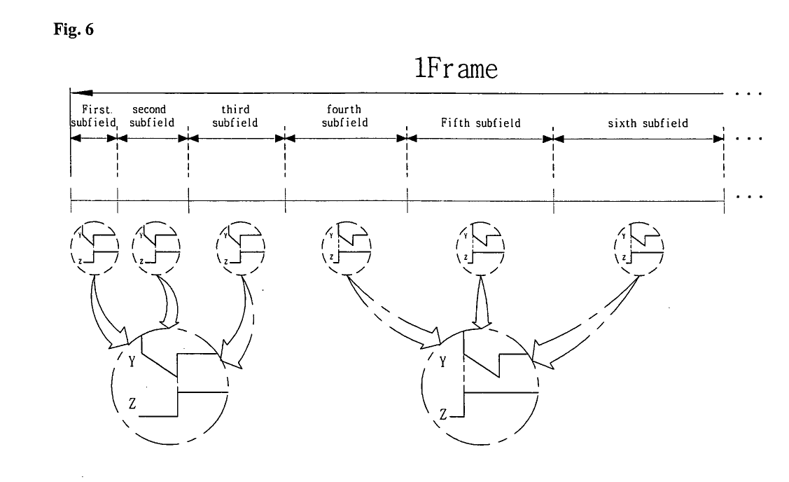

The above descriptions are limited to one subfield, but the first sustain bias voltage (Vzb1) that is less than the second sustain bias voltage (Vzb2) may be set to be supplied only in a predetermined subfield within one frame and it will be described with reference to FIG. 6.

FIG. 6 is a diagram illustrating an embodiment in which a first sustain bias voltage (Vzb1) is supplied only in a predetermined subfield within one frame.

Referring to FIG. 6, in an address period of the first, second, and third subfields among subfields of the frame, the first sustain bias voltage (Vzb1) that is less than the second sustain bias voltage (Vzb2) supplied to the sustain electrode (Z) is supplied to the sustain electrodes from a setdown period of a reset period before the address period to a period before a first scan pulse is supplied to the scan electrodes and the second sustain bias voltage (Vzb2) is supplied to the sustain electrode (Z) in the setdown period in the remaining subfields.

Preferably, in the address period of the subfields, for example, the first, the second, and the third subfields in which a gray level weight is relatively low within one frame, the first sustain bias voltage (Vzb1), which is less than the second sustain bias voltage (Vzb2) supplied to the sustain electrode (Z), is supplied to the sustain electrodes from the setdown period of the reset period before the address period to a period before a first scan pulse is supplied to the scan electrodes and the second sustain bias voltage (Vzb2) is supplied in the setdown period of the remaining subfields.

The reason why in the address period only in a predetermined subfield, preferably, the subfields in which a gray level weight is relatively low within one frame, the first sustain bias voltage (Vzb1), which is less than the second sustain bias voltage (Vzb2) supplied to the sustain electrode (Z), is supplied from a setdown period of a reset period before the address period to a period before a first scan pulse is supplied to the scan electrodes (Y) is that there is a relatively high probability that the address discharge in the address period will become unstable in a subfield in which a gray level weight is low. Therefore, since in an address period of a subfield in which a gray level weight is relatively low, the first sustain bias voltage (Vzb1) that is less than the second sustain bias voltage (Vzb2) supplied to the sustain electrode (Z) from a setdown period of a reset period before the address period to a period before a first scan pulse is supplied to the scan electrodes (Y), the address discharge becomes stable in a subfield having a relatively high probability that the address discharge will become unstable, that is, a subfield in which a gray level weight is relatively low, whereby entire driving becomes stable.

Next, as described above, in a method of driving the plasma display apparatus according to the present invention, a first sustain bios voltage (Vzb1), which is less than a second sustain bios voltage (Vzb2) supplied to the sustain electrodes (Z) in the address period, is supplied from a setdown period of a reset period before the address period to a period before a first scan pulse is supplied to the scan electrodes (Y) and scan electrodes. (Y) are scanned with one scan type among a plurality of scan types having different scan orders which scan the plurality of scan electrodes in an address period. A method of scanning the scan electrodes (Y) with one scan type among a plurality of scan types having a different scan order which scan the plurality of scan electrodes (Y) in the address period will be described.

An important factor for determining one scan type among the plurality of scan types is a magnitude of a displacement current (Id) depending on image data and it is described with reference to the attached FIG. 7.

FIG. 7 is a diagram illustrating a magnitude of a displacement current depending on inputted image data.

Referring to FIG. 7, when the second scan electrode (Y2) is scanned as in (a), that is, when scan pulses are supplied to the second scan electrode (Y2), image data in which logic values 1 (High) and 0 (Low) alternately appear are applied to the data electrodes, for example, a X1 data electrode to a Xm data electrode. When the third scan electrode (Y3) is scanned, logic value 0 is stored in the data electrode (X). Logic value 1 indicates that a voltage of data pulse, that is, a data voltage (Vd) is applied to the corresponding data electrode (X) and logic value 0 indicates that a voltage of 0V is applied to the corresponding data electrode (X), that is, that a data voltage is not supplied.

Image data in which logic values 1 and 0 alternately change are applied to a discharge cell on one scan electrode (Y) and image data in which logic value 0 is maintained are applied to a discharge cell on the next scan electrode (Y). A displacement current (Id) flowing to each data electrode (X) is represented by equation 1.
Id=½(Cm1+Cm2)Vd <Equation 1>

Id: s displacement current flowing to each data electrode (X)

Cm1: an equivalent capacitance between data electrodes (X)

Cm2: an equivalent capacitance between the data electrode (X) and the scan electrode (Y) or the data electrode (X) and the sustain electrode (Z)

Vd: a voltage of data pulse applied to each data electrode (X)

When the second scan electrode (Y2) is scanned as in (b), image data in which logic value 1 is stored are applied to data electrodes (X1 to Xm). When the third scan electrode (Y3) is scanned, image data in which logic value 0 is stored are applied to data electrodes (X1 to Xm). As described above, logic value 0 indicates that a voltage of 0V is applied to the corresponding X electrode, that is, that a data voltage (Vd) is not supplied.

Image data in which logic value 1 is stored are applied to a discharge cell on one scan electrode (Y) and image data in which logic value 0 is stored are applied to a discharge cell on the next scan electrode (Y). Image data in which logic value 0 is stored are applied to a discharge cell on one scan electrode (Y) and image data in which logic value 1 is stored are applied to a discharge cell on the next scan electrode (Y).

A displacement current (Id) flowing to each data electrode (X) is represented by equation 2.
Id=½(Cm2)Vd <Equation 2>

Id: a displacement current flowing to each data electrode (X)

Cm2: an equivalent capacitance between the data electrode (X) and the scan electrode (Y) or the data electrode (X) and the sustain electrode (Z)

Vd: a voltage of data pulse applied to each data electrode (X)

When the second scan electrode (Y2) is scanned as in (c), image data in which logic values 1 and 0 alternatively change are applied to data electrodes (X1 to Xm). When the third scan electrode (Y3) is scanned, image data in which logic values 1 and 0 alternatively change are applied so that a difference between a phase of data and a phase of image data applied to a discharge cell on the second scan electrode (Y2) is 180°.

That is, image data in which logic values 1 and 0 alternatively change are applied to a discharge cell on one scan electrode (Y) and image data in which logic values 1 and 0 alternatively change are applied so that a difference between a phase of data and a phase of image data applied to a discharge cell on the one scan electrode (Y) to a discharge cell on the next scan electrode (Y) is 180°.

A displacement current (Id) flowing to each data electrode (X) is represented by equation 3.
Id=½(4Cm1+Cm2)Vd <Equation 3>

Id: a displacement current flowing to each data electrode (X)

Cm2: an equivalent capacitance between the data electrode (X) and the scan electrode (Y) or the data electrode (X) and the sustain electrode (Z)

Vd: a voltage applied to each data electrode (X)

When the second scan electrode (Y2) is scanned as in (d), image data in which logic values 1 and 0 alternatively change are applied to data electrodes (X1 to Xm). When the third scan electrode (Y3) is scanned, image data in which logic values 1 and 0 alternatively change to be identical to a phase of image data applied to a discharge cell on the second scan electrode (Y) are applied.

That is, image data in which logic values 1 and 0 alternatively change are applied to a discharge cell on one scan electrode and image data in which logic values 1 and 0 alternatively change to be identical to a phase of image data applied to a discharge cell on the one scan electrode (Y) are applied to a discharge cell on the next scan electrode (Y).

A displacement current (Id) flowing to each data electrode (X) is represented by equation 4.
Id=0 <Equation 4>

Id: a displacement current flowing to each data electrode (X)

Cm2: an equivalent capacitance between the data electrode (X) and the scan electrode (Y) or the data electrode (X) and the sustain electrode (Z)

Vd: a voltage applied to each data electrode (X)

When the second scan electrode (Y2) is scanned as in (e), image data in which logic value 0 is stored are applied to data electrodes (X1 to Xm). When the third scan electrode (Y3) is scanned, image data in which logic value 0 is stored are applied to the third electrode (Y3).

That is, image data in which logic value 0 is stored are applied to a discharge cell on one scan electrode (Y) and image data in which logic value 0 is kept are also applied to a discharge cell on the next scan electrode (Y).

Image data in which logic value 1 is stored are applied to a discharge cell on one scan electrode (Y) and image data in which logic value 1 is stored are applied to the discharge cell on the next scan electrode (Y).

A displacement current (Id) flowing to each data electrode (X) is represented by equation 5.
Id=0 <Equation 5>

Id: a displacement current flowing to each data electrode (X)

Cm2: an equivalent capacitance between the data electrode (X) and the scan electrode (Y) or the data electrode (X) and the sustain electrode (Z)

Vd: a voltage applied to each data electrode (X)

Shown in equations 1 to 5, when image data in which logic values 1 and 0 alternatively change are applied to a discharge cell on one scan electrode (Y) and when image data in which logic values 1 and 0 alternatively change are applied so that a difference between a phase of data and a phase of image data applied to a discharge cell on the one scan electrode (Y) to a discharge cell on the next scan electrode (Y) is 180°, the largest displacement current (Id) flows to the data electrode (X).

When image data in which logic values 1 and 0 alternatively change are applied to a discharge cell on one scan electrode (Y) and image data in which logic values 1 and 0 alternatively change to be identical to a phase of image data applied to the discharge cell on the one scan electrode (Y) are applied to a discharge cell on the next scan electrode (Y) or when image data in which logic value 0 is stored are applied to all of a discharge cell on one scan electrode (Y) and a discharge cell on the next scan electrode (Y), the lowest displacement current (Id) flows to the data electrode (X).

Referring to FIG. 7, when image data having different logic values is alternatively supplied as in (c) of FIG. 7, the largest displacement current (Id) flows, and, as such, there is a high probability that there will be electrical damage a data driver integrated circuit.

In order words, from viewpoint of data driver unit integrated circuit serving as one data electrode (X), image data such as (c) of FIG. 7 has the largest number of times the data driver integrated circuit switched. As the number of times the data driver integrated circuit switched becomes large, a displacement current (Id) flowing to the data electrode (X) becomes large, so that there is a high probability that there will be electrical damage to the data driver integrated circuit.

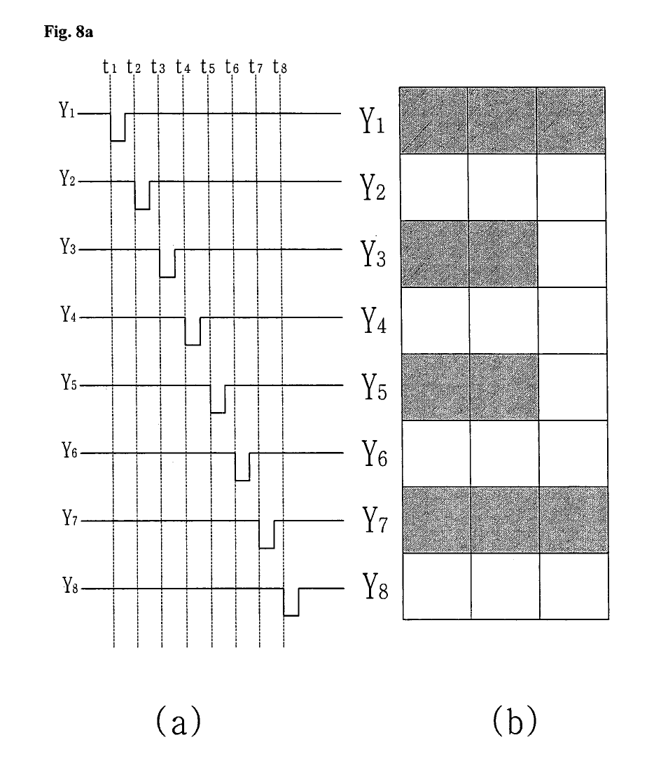

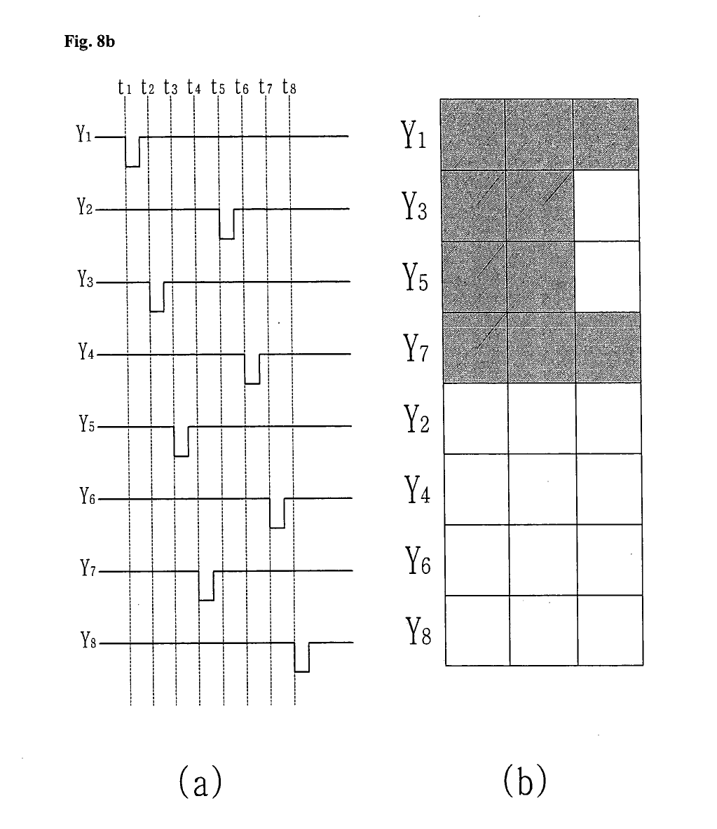

An embodiment of a method of changing a scan order by considering the image data and a magnitude of a displacement current depending on the image data will be described with reference to FIGS. 8a and 8b.

FIGS. 8a and 8b are diagrams illustrating an embodiment of a method of changing a scan order by considering image data and a displacement current depending on the image data.

Referring to FIGS. 8a and 8b, it can be confirmed that the same image data having different scanning orders are shown in FIGS. 8a and 8b.

Referring to FIG. 8a, if the scan electrodes (Y) are scanned in an order such as (a) when image data having a pattern such as (b) are supplied, a relatively large displacement current is generated because a logic value of image data frequently changes in an arrangement direction of scan electrodes (Y).

When a scan order of the scan electrodes (Y) is readjusted as in (a) of FIG. 8b, image data having such a pattern is arranged as in (b) of FIG. 8b. Then, a generating displacement current also decreases because a frequency in which logic values of image data change decreases in an arrangement direction of the scan electrodes (Y).

As a result, if a scan order of scan electrodes (Y) is adjusted depending on image data as in a case of FIG. 8b, a magnitude of a displacement current flowing to the data driver integrated circuit decreases, so that the possibility of electrical damage to the data driver integrated circuit decreases.

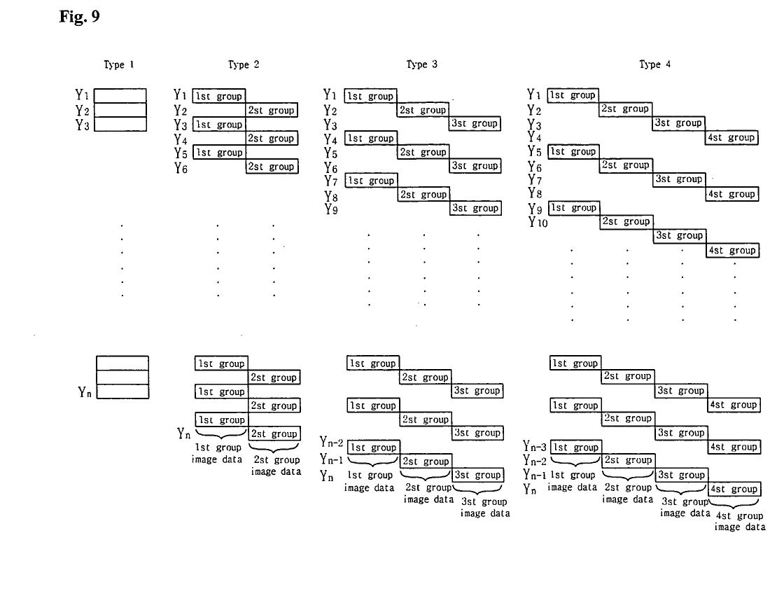

A method of driving the plasma display apparatus according to the present invention was developed based on a principle in FIGS. 8a and 8b and another embodiment of the method of driving the plasma display apparatus of the present invention will be described with reference to the attached FIG. 9.

FIG. 9 is a diagram illustrating another embodiment of a method of driving the plasma display apparatus according to the present invention.

Referring to FIG. 9, in the method of driving the plasma display apparatus according to the present invention, scanning can be performed with the selected one scan type among scan orders of total 4 scan types, that is, the first type (Type 1), the second type (Type 2), the third type (Type 3) and the fourth type (Type 4).

The scan of the first scan type (Type 1) is performed in an arranged order of scan electrodes (Y) such as Y1-Y2-Y3- . . . .

According to a scan order of the second scan type (Type 2), scan electrodes (Y) belonging to the first group are sequentially scanned and scan electrodes (Y) belonging to the second group are sequentially scanned. That is, scan electrodes Y1-Y3-Y5- . . . Yn−1 are scanned and then scan electrodes Y2-Y4-Y6- . . . Yn are scanned.

According to a scan order of the third scan type (Type 3), scan electrodes (Y) belonging to the first group are sequentially scanned, scan electrodes (Y) belonging to the second group are sequentially scanned, and scan electrodes (Y) belonging to the third group are sequentially scanned. That is, scan electrodes Y1-Y4-Y7- . . . Yn−2 are scanned, then scan electrodes Y2-Y5-Y8- . . . Yn−1 are scanned, and then scan electrodes Y3-Y6-Y9- . . . Yn are scanned.

According to a scan order of the fourth scan type (Type 4), scan electrodes (Y) belonging to the first group are sequentially scanned, scan electrodes (Y) belonging to the second group are sequentially scanned, scan electrodes (Y) belonging to the third group are sequentially scanned, and scan electrodes (Y) belonging to the fourth group are sequentially scanned. That is, scan electrodes Y1-Y5-Y9- . . . Yn−3 are scanned, then scan electrodes Y2-Y6-Y10- . . . Yn−2 are scanned, then scan electrodes Y3-Y7-Y1 . . . Yn−1 are scanned, and then scan electrodes Y4-Y8-Y12- . . . Yn are scanned.

In FIG. 9, the 4 scan types are shown and only a method of selecting one scan type among the 4 scan types and scanning scan electrodes (Y) is shown, but there are scan types of various numbers such as 2 scan types, 3 scan types, and 5 scan types, so that it is possible to select one scan type among these scan types and scan the scan electrodes (Y).

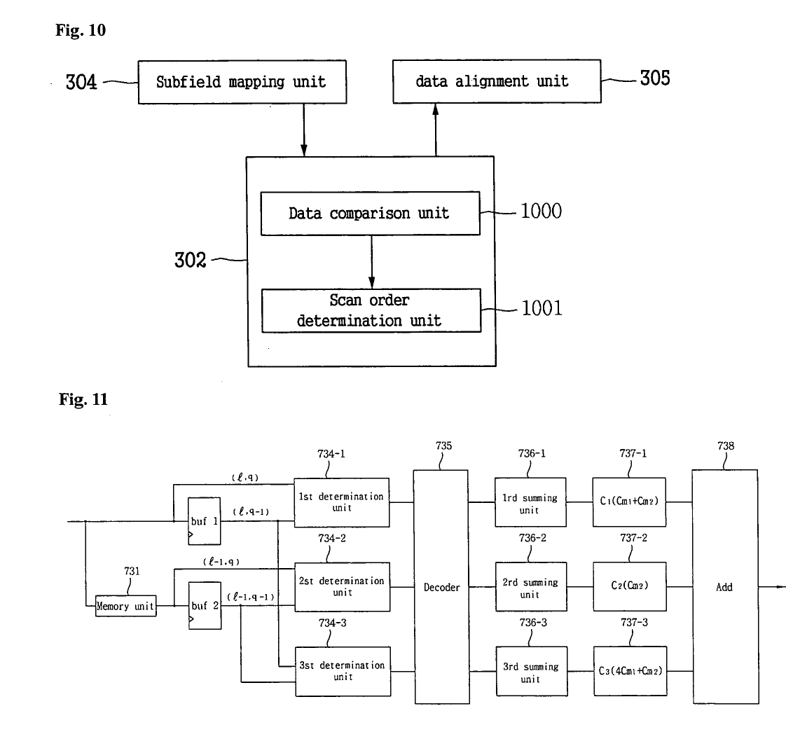

A detailed construction of the scan driver 202 shown in FIG. 2 for scanning scan electrodes (Y) with one scan type among a plurality of scan types will be described with reference to the attached FIG. 10.

FIG. 10 is a diagram illustrating in detail a construction and an operation of a scan driver for embodying a method of driving the plasma display apparatus according to the present invention.

Referring to FIG. 10, the scan driver for embodying a method of driving the plasma display apparatus according to the present invention may comprise a data comparing unit 1000 and a scan order determining unit 1001.

The data comparing unit 1000 receives image data mapped by the subfield mapping unit 204, compares image data of a cell bundle consisting of one or more discharge cells positioned in a specific scan electrode (Y) line with that of a cell bundle positioned in vertical and horizontal directions of a cell bundle depending on each of a plurality of scan types, and thus calculates a magnitude of a displacement current.

A cell bundle means a unit composed of one or more cell. For example, since cells corresponding to R, G and B are composed of one pixel, the pixel corresponds to a cell bundle.

The scan order determining unit 1001 determines the scan order depending on a scan type in which a magnitude of a displacement current is lowest by using information on a magnitude of a displacement current in which the data comparing unit 1000 calculates.

Information on the scan order determined by the scan order determining unit 1001 is applied to the data arranging unit 205 and the data arranging unit 205 re-arranges image data which are subfield-mapped by the subfield mapping unit 204 depending on the scan order determined by the scan order determining unit 1001 and supplies the re-arranged image data to the data electrode (X).

Referring to a construction of the scan driver 202 shown in FIG. 10 together with that of FIG. 9, magnitudes of displacement currents for 4 scan types in FIG. 9 are calculated by the data comparing unit 1000 shown in FIG. 10. When information on magnitudes of displacement currents for such 4 scan types is applied to the scan order determining unit 1001, the scan order determining unit 1001 compares the magnitudes of each displacement current for the 4 scan types and selects one scan type having the lowest magnitude among them. For example, if a magnitude of a displacement current for the first scan type is 10, a magnitude of a displacement current for the second scan type is 15, a magnitude of a displacement current for the third scan type is 11, and a magnitude of a displacement current for the fourth scan type is 8, the scan order determining unit 1001 selects the fourth scan type and a scan order of scan electrodes (Y) is determined based on the fourth scan type.

If magnitudes of displacement currents for scan types, that is, the first, the third, the fourth scan types except the second scan type among total 4 scan types are low enough not to cause electrical damage to a data driver integrated circuit, the scan order determining unit 1001 can select any scan type among the first, the third, the fourth scan types.

Information on enough low current not to cause electrical damage to the data driver integrated circuit can be preset. That is, the largest value of enough low current not to cause electrical damage to the data driver integrated circuit can be preset as a critical current and a scan type generating a displacement current less than a critical current can be selected.

The data comparing unit 1000 shown in FIG. 10 will be described in detail with reference to the attached FIG. 11.

FIG. 11 is a diagram of a basic circuit block included in a data comparing unit 1000 included in the scan driver of the plasma display apparatus according to the present invention.

As shown in FIG. 11, the basic circuit block included in a data comparing unit 1000 of the scan driver of the plasma display apparatus according to the present invention comprises a memory 731, a first buffer (buf1), a second buffer (buf2), a first judging unit to third judging units (734-1, 734-2, 734-3), a decoder 735, a first to third adders (736-1, 736-2, 736-3), a first to third current calculators (737-1, 737-2, 737-3), and a current adder 738.

Image data corresponding to a ( [symbol] −1)th scan electrode, that is, a ( [symbol] −1)th scan electrode line are stored in the memory 731 and image data corresponding to a [symbol] th scan electrode, that is, a [symbol] th scan electrode line are inputted.

The first buffer (buf1) temporarily stores image data of a (q−1)th discharge cell among discharge cells corresponding to the [symbol] th scan electrode line.

The second buffer (buf2) temporarily stores image data of a (q−1)th discharge cell among discharge cells corresponding to the ( [symbol] −1)th scan electrode line stored in the memory 731.

The first judging unit (734-1) comprises an exclusive OR gate, compares image data of the qth discharge cell of a [symbol] th scan electrode line with image data of the (q−1)th discharge cell of the [symbol] th scan electrode line stored in the first buffer (buf1) and outputs 1 if they are different and outputs 0 if they are the same.

The second judging unit (734-2) comprises an exclusive OR gate, compares image data of the qth discharge cell of a ( [symbol] −1)th scan electrode line with image data of the (q−1)th discharge cell of the ( [symbol] −1)th scan electrode line stored in the second buffer (buf2) and thus outputs 1 if they are different and outputs 0 if they the same.

The third judging unit (734-3) comprises an exclusive OR gate, compares image data of the (q−1)th discharge cell of the [symbol] th scan electrode line stored in the first buffer (buf1) with image data of the (q−1)th discharge cell of the ( [symbol] −1)th scan electrode line stored in the second buffer (buf2) and outputs 1 if they are different and outputs 0 if they the same.

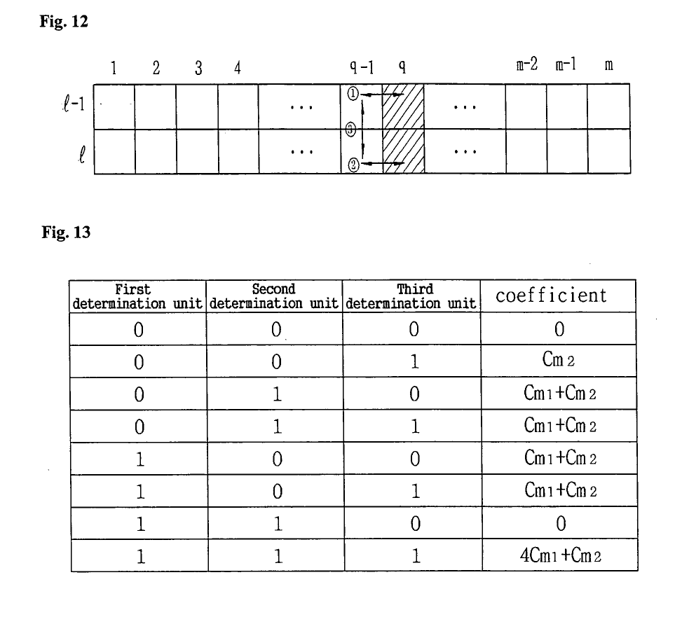

An operation of the first to the third judging units included in a basic circuit block of the data comparing unit 1000 having the above construction will be described with reference to the attached FIG. 12.

FIG. 12 is a diagram illustrating in detail an operation of a first judging unit to a third judging unit of the data comparing unit. Reference numerals \textcircled{1} \textcircled{2} and \textcircled{3} indicate operations of the first judging unit (734-1), the second judging unit (734-2), and the third judging unit (734-3), respectively.

Referring to FIG. 12, the data comparing unit 1000 of the present invention compares image data of adjacent cells in a horizontal direction and a vertical direction of one cell through the first judging unit (734-1) to the third judging unit (734-3) and analyzes the change.

The decoder 735 outputs a 3 bit signal corresponding to each output signal of the first judging unit to the third judging unit (734-1, 734-2, 734-3).

FIG. 13 is a diagram illustrating pattern contents of image data depending on output signals of the first judging unit to the third judging unit (734-1, 734-2, 734-3) included in the basic circuit block of the data comparing unit of the present invention.

Referring to FIG. 13, if each output signal of the first judging unit to third judging unit (734-1, 734-2, 734-3) is (0, 0, 0), the pattern thereof is the same as that of image data shown in (e) of FIG. 7. Therefore, if the output signal is (0, 0, 0), the displacement current (Id) is 0.

If each output signal of the first to third judging units (734-1, 734-2, 734-3) is (0, 0, 1), the pattern thereof is the same as that of image data shown in (b) of FIG. 7. Therefore, if the output signal is (0, 0, 1), the displacement current (Id) is proportional to Cm2.

If each output signal of the first to third judging units (734-1, 734-2, 734-3) is any one among (0, 1, 0), (0, 1, 1), (1, 0, 0), and (1, 0, 1), the pattern thereof is the same as that of image data shown in (a) of FIG. 7. Therefore, if the output signal is any one among (0, 1, 0), (0, 1, 1), (1, 0, 0), and (1, 0, 1), the displacement current (Id) is proportional to (Cm1+Cm2).

If each output signal of the first to third judging units (734-1, 734-2, 734-3) is (1, 1, 0), the pattern thereof is the same as that of image data shown in (d) of FIG. 7. Therefore, if the output signal is (1, 1, 0), the displacement current (Id) is 0.

If each output signal of the first to third judging unit (734-1, 734-2, 734-3) is (1, 1, 1), the pattern thereof is the same as that of image data shown in (c) of FIG. 7. Therefore, if the output signal is (1, 1, 1), the displacement current (Id) is proportional to (4Cm1+Cm2).

In addition, a first adder to a third adder (736-1, 736-2, 736-3) shown in FIG. 11 adds the number of outputs of a specific 3 bit signal outputted from the decoder 735 and outputs the added number.

That is, the first adder (736-1) adds (C1) the number in which the decoder 735 outputs any one among (0, 1, 0), (0, 1, 1), (1, 0, 0), and (1, 0, 1). The second adder (736-2) adds (C2) the number in which the decoder 735 outputs (0, 0, 1). The third adder (736-3) adds (C3) the number in which the decoder 735 outputs (1, 1, 1).

Each of a first to third current calculators (737-1, 737-2, 737-3) receives C1, C2 and C3 from the first adder (736-1), the second adder (736-2), and the third adder (736-3) and calculates a magnitude of a displacement current.

A current adder 738 adds the magnitudes of displacement currents calculated from each of the first to third current calculators (737-1, 737-2, 737-3).

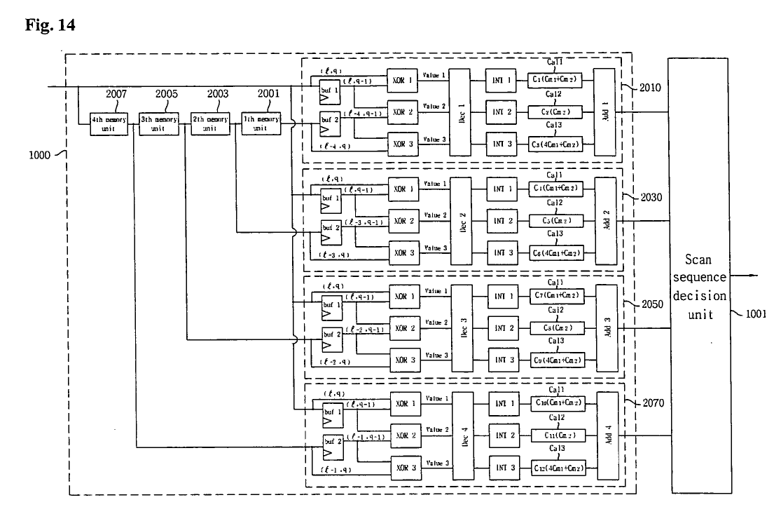

FIG. 14 is a block diagram of the data comparing unit 1000 and the scan order determining unit 1001 of the scan driver in the plasma display apparatus according to the present invention.

As shown in FIG. 14, the data comparing unit 1000 of the scan driver in the plasma display apparatus according to the present invention has a construction in which four basic circuit blocks shown in FIG. 14 are connected to each other and the scan order determining unit 1001 determines a scan order generating the smallest displacement current by comparing the output of the four basic circuit blocks. FIG. 14 shows total 4 scan types as in FIG. 9. That is, the construction thereof comprises the data comparing unit 1000 and the scan order determining unit 1001 required when scan electrodes (Y) are scanned with one scan type among total 4 scan types.

The data comparing unit 1000 comprises a first to fourth memories 901, 903, 905 and 907 and a first current discriminator to fourth current discriminators 910, 930, 950 and 970. That is, one memory and one current discriminator correspond to a basic circuit block shown in FIG 11.

Since the first to fourth memories 901, 903, 905 and 907 are connected in series to each other, image data corresponding to 4 scan electrode (Y) lines is stored. That is, the first memory 901 stores image data corresponding to a ( [symbol] −4)th scan electrode (Y) line, the second memory 903 stores image data corresponding to a ( [symbol] −3)th scan electrode (Y) line, the third memory 905 stores image data corresponding to a ( [symbol] −2)th scan electrode (Y) line, and the fourth memory 907 stores image data corresponding to a ( [symbol] −1)th scan electrode (Y) line.

The first current discriminator 910 receives image data of the [symbol] th scan electrode (Y) line and that of a ( [symbol] −4)th scan electrode (Y) line stored in the first memory 901. If a magnitude of a current of the first current discriminator 910 which receives such image data is less than the magnitude of the currents of the second to fourth current discriminators 930, 950 and 970, the scan order thereof is the same as that of the fourth scan type (Type 4) shown in FIG. 9. That is, it should be scanned in an order of Y1-Y5-Y9- . . . , Y2-Y6-Y1- . . . , Y3-Y7-Y11- . . . , Y4-Y8-Y12- . . . .

An operation of the first current discriminator 910 is the same as that of the basic circuit block. Image data corresponding to the ( [symbol] −4)th scan electrode (Y) line are stored in the first memory 901 and image data corresponding to the [symbol] th scan electrode (Y) line are inputted.

The first buffer (buf1) temporarily stores image data of the (q−1)th discharge cell among the discharge cells corresponding to the [symbol] th scan electrode (Y) line.

The second buffer (buf2) temporarily stores image data of the (q−1)th discharge cell among the discharge cells corresponding to the ( [symbol] −4)th scan electrode (Y) line stored in the first memory 901.

The first judging unit (XOR1) comprises an exclusive OR gate, compares image data ( [symbol] , q) of the qth discharge cell of the [symbol] th scan electrode (Y) line with image data ( [symbol] , q−1) of the (q−1)th discharge cell of the [symbol] th scan electrode (Y) line stored in the first buffer (buf1), and outputs Value=1 if they are different and Value=0 if they are the same.

The second judging unit (XOR2) comprises an exclusive OR gate, compares image data ( [symbol] , q−1) of the (q−1)th discharge cell of the [symbol] th scan electrode (Y) line with image data ( [symbol] −4, q−1) of the (q−1)th discharge cell of the ( [symbol] −4)th scan electrode (Y) line stored in the second buffer (buf2), and outputs Value=1 if they are different and Value=0 if they are the same.

The third judging unit (XOR3) comprises an exclusive OR gate, compares image data ( [symbol] −4, q−1) of the (q−1)th discharge cell of the ( [symbol] −4)th scan electrode (Y) line stored in the second buffer (buf2) with image data ( [symbol] −4, q) of the qth discharge cell of the ( [symbol] −4)th scan electrode (Y) line outputted from the first memory 901, and outputs Value=1 if they are different and Value=0 if they are the same.

The first decoder (Dec1) receives in parallel each output signal of the first judging unit to the third judging unit (XOR1, XOR2, XOR3) and outputs a 3 bit signal.

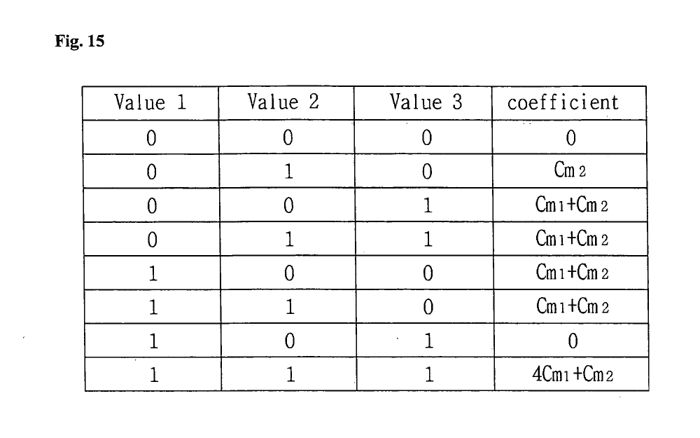

FIG. 15 is a diagram illustrating pattern the contents of the image data depending on the output signals of the first to third judging units (XOR1, XOR2, XOR3) included in the data comparing unit of the present invention.

Referring to FIG. 15, a magnitude of capacitance determining a magnitude of a displacement current changes depending on output signals (Value1, Value2, Value3) of the first to third judging units (XOR1, XOR2, XOR3).

The first adder to third adder (Int1, Int2, Int3) add the number of outputs of a specific 3 bit signal outputted from the first decoder (Dec1) and outputs the added number.

That is, the first adder (Int1) adds (C1) the number in which the first decoder (Dec1) outputs any one among (0, 0, 1), (0, 1, 1), (1, 0, 0), and (1, 1, 0). The second adder (Int2) adds (C2) the number in which the first decoder (Dec1) outputs (0, 1, 0). The third adder (Int3) adds (C3) the number in which the first decoder (Dec1) outputs (1, 1, 1).

Each of the first to third current calculators (Cal1, Cal2, Cal3) receives C1, C2, and C3 from the first adder (Int1), the second adder (Int2), and the third adder (Int3) and calculates a magnitude of a displacement current.

The first current calculator (Cal1) calculates a magnitude of a current by multiplying the output (C1) of the first adder (Int1) by (Cm1+Cm2). The second current calculator (Cal2) calculates a magnitude of a current by multiplying the output (C2) of the second adder (Int2) by Cm2. The third current calculator (Cal3) calculates a magnitude of a current by multiplying the output (C3) of the third adder (Int3) by (4Cm1+Cm2).

The first current adder (Add1) adds a magnitude of a displacement current calculated from each of the first to third current calculators (Cal1, Cal2, Cal3).

A magnitude of the added displacement current is calculated by operating the second to fourth current discriminators 930, 950 and 970, similar to an operation of the first current discriminator.

The first judging unit (XOR1) of the second current discriminator 930 comprises an exclusive OR gate, compares image data ( [symbol] , q) of the qth discharge cell of the [symbol] th scan electrode (Y) line with image data ( [symbol] , q−1) of the (q−1)th discharge cell of the [symbol] th scan electrode (Y) line stored in the first buffer (buf1), and outputs 1 if they are different and 0 if they are the same.

The second judging unit (XOR2) of the second current discriminator 930 comprises an exclusive OR gate, compares image data ( [symbol] , q−1) of the (q−1)th discharge cell of the [symbol] th scan electrode (Y) line with image data ( [symbol] −3, q−1) of the (q−1)th discharge cell of the ( [symbol] −3)th scan electrode (Y) line stored in the second buffer (buf2), and outputs 1 if they are different and 0 if they are the same.

The third judging unit (XOR3) of the second current discriminator 930 comprises an exclusive OR gate, compares image data ( [symbol] −3, q−1) of the (q−1)th discharge cell of the ( [symbol] −3)th scan electrode (Y) line stored in the second buffer (buf2) with image data ( [symbol] −3, q) of the qth discharge cell of the ( [symbol] −3)th scan electrode (Y) line outputted from the second memory 903, and outputs 1 if they are different and 0 if they are the same.

The first judging unit (XOR1) of the third current discriminator 950 comprises an exclusive OR gate, compares image data ( [symbol] , q) of the qth discharge cell of the [symbol] th scan electrode (Y) line with image data ( [symbol] , q−1) of the (q−1)th discharge cell of the [symbol] th scan electrode (Y) line stored in the first buffer (buf1), and outputs 1 if they are different and 0 if they are the same.

The second judging unit (XOR2) of the third current discriminator 950 comprises an exclusive OR gate, compares image data ( [symbol] , q−1) of the (q−1)th discharge cell of the [symbol] th scan electrode (Y) line with image data ( [symbol] −2, q−1) of the (q−1)th discharge cell of the ( [symbol] −2)th scan electrode (Y) line stored in the second buffer (buf2), and outputs 1 if they are different and 0 if they are the same.

The third judging unit (XOR3) of the third current discriminator 950 comprises an exclusive OR gate, compares image data ( [symbol] −2, q−1) of the (q−1)th discharge cell of the ( [symbol] −2)th scan electrode (Y) line stored in the second buffer (buf2) with image data ( [symbol] −2, q) of the qth discharge cell of the ( [symbol] −2)th scan electrode (Y) line outputted from the third memory 905, and outputs 1 if they are different and 0 if they are the same.

The first judging unit (XOR1) of the fourth current discriminator 970 comprises an exclusive OR gate, compares image data ( [symbol] , q) of the qth discharge cell of the [symbol] th scan electrode (Y) line with image data ( [symbol] , q−1) of the (q−1)th discharge cell of the [symbol] th scan electrode (Y) line stored in the first buffer (buf1), and outputs 1 if they are different and 0 if they are the same.

The second judging unit (XOR2) of the fourth current discriminator 970 comprises an exclusive OR gate, compares image data ( [symbol] , q−1) of the (q−1)th discharge cell of the [symbol] th scan electrode (Y) line with image data ( [symbol] −1, q−1) of the (q−1)th discharge cell of the ( [symbol] −1)th scan electrode (Y) line stored in the second buffer (buf2), and outputs 1 if they are different and 0 if they are the same.

The third judging unit (XOR3) of the fourth current discriminator 970 comprises an exclusive OR gate, compares image data ( [symbol] −1, q−1) of the (q−1)th discharge cell of the ( [symbol] −1)th scan electrode (Y) line stored in the second buffer (buf2) with image data ( [symbol] −1, q) of the qth discharge cell of the ( [symbol] −1)th scan electrode (Y) line outputted from the fourth memory 907, and outputs 1 if they are different and 0 if they are the same.

The scan order determining unit 1001 receives magnitudes of displacement currents calculated by each of the first to fourth current discriminators 910, 930, 950 and 970 and determines a scan order depending on a current discriminator outputted the smallest displacement current among them. Otherwise, the scan order determining unit 1001 determines a scan order of scan electrodes (Y) depending on any one among scan types which generates a displacement current that is less than or equal to a preset critical current.

For example, if it is determined that a magnitude of a displacement current in which the scan order determining unit 1001 receives from the second current discriminator 930 is lowest, the scan order determining unit 1001 scans in an order of Y1-Y4-Y7- . . . , Y2-Y5-Y8-. . . , Y3-Y6-Y9- . . . as in the third scan type (Type 3) of FIG. 9.

If it is determined that a magnitude of a displacement current in which the scan order determining unit 1001 receives from the third current discriminator 950 is lowest, the scan order determining unit 1001 scans in an order of Y1-Y3-Y5- . . . , Y2-Y4-Y6- . . . as in the second scan type (Type 2) of FIG. 9.

If it is determined that a magnitude of a displacement current in which the scan order determining unit 1001 receives from the fourth current discriminator 970 is lowest, the scan order determining unit 1001 scans in an order of Y1-Y2-Y3-Y4-Y5-Y6- . . . as in the first scan type (Type 1) of FIG. 9.

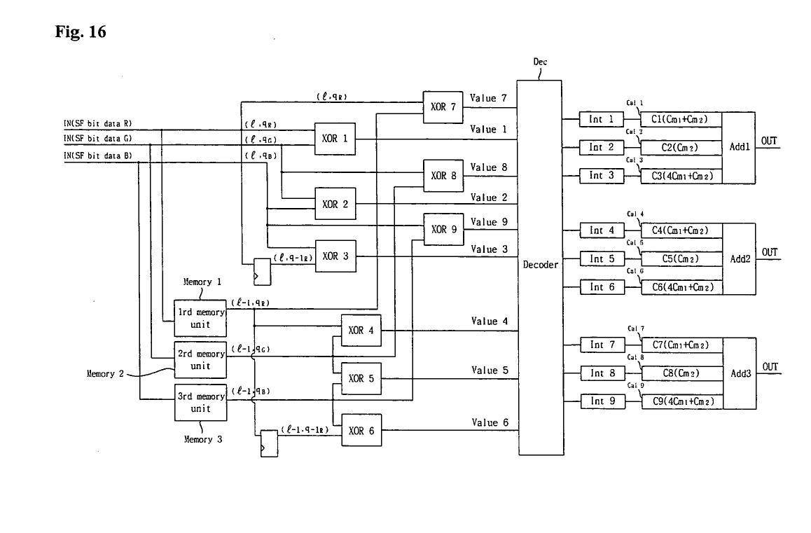

A basic circuit block included in the data comparing unit 1000 of the scan driver in the plasma display apparatus according to the present invention described in FIG. 11 may be constructed to be different with that shown in FIG. 11 and it will be described with reference to the attached FIG. 16.

FIG. 16 is a diagram illustrating another configuration of a basic circuit block included in the data comparing unit 1000 included in the scan driver of the plasma display apparatus according to the present invention.

Referring to FIG. 16, a basic circuit block shown in FIG. 16 calculates the magnitudes of the displacement currents through the change of image data corresponding to R, G, B cells of the qth pixel and the (q−1)th pixel on the [symbol] th scan electrode line, the change of image data corresponding to R, G, B cells of the qth pixel and the (q−1)th pixel on the ( [symbol] −1)th scan electrode line, and the change of image data corresponding to R, G, B cells of the qth pixel on the [symbol] th scan electrode line and the (q−1)th pixel on the ( [symbol] −1)th scan electrode line.

Each of the first memory to the third memorie (Memory1, Memory2, Memory3) temporarily stores image data corresponding to the R cell, image data corresponding to the G cell, and image data corresponding to the B cell of ( [symbol] −1)th scan electrode line.

The first judging unit to third judging units (XOR1, XOR2, XOR3) judge the change between image data corresponding to R, G, B cells of the qth pixel on the [symbol] th scan electrode line.

That is, the first judging unit (XOR1) compares image data ( [symbol] , qR) corresponding to R cell of the qth pixel on the [symbol] th scan electrode line with image data ( [symbol] , qG) corresponding to G cell of the qth pixel on the [symbol] th scan electrode line and outputs logic value 1 if they are the same and logic value 0 if they are different.

The second judging unit (XOR2) compares image data ( [symbol] , qG) corresponding to G cell of the qth pixel on the [symbol] th scan electrode line with image data ( [symbol] , qB) corresponding to B cell of the qth pixel on the [symbol] th scan electrode line and outputs logic value 1 if they are the same and logic value 0 if they are different.

The third judging unit (XOR3) compares image data ( [symbol] , qB) corresponding to B cell of the qth pixel on the [symbol] th scan electrode line with image data ( [symbol] , q−1R) corresponding to R cell of the (q−1)th pixel on the [symbol] th scan electrode line and outputs logic value 1 if they are the same and logic value 0 if they are different.

The fourth judging unit to sixth judging units (XOR4, XOR5, XOR6) judge the change between image data corresponding to R, G, B cells of the qth pixel on the ( [symbol] −1)th scan electrode line.

That is, the fourth judging unit (XOR4) compares image data ( [symbol] −1, qR) corresponding to R cell of the qth pixel on the ( [symbol] −1)th scan electrode line with image data ( [symbol] −1, qG) corresponding to G cell of the qth pixel on the ( [symbol] −1)th scan electrode line and outputs logic value 1 if they are the same and logic value 0 if they are different.

The fifth judging unit (XOR5) compares image data ( [symbol] −1, qG) corresponding to G cell of the qth pixel on the ( [symbol] −1)th scan electrode line with image data ( [symbol] −1, qB) corresponding to B cell of the qth pixel on the ( [symbol] −1)th scan electrode line and outputs logic value 1 if they are the same and logic value 0 if they are different.

The sixth judging unit (XOR6) compares image data ( [symbol] −1, qB) corresponding to B cell of the qth pixel on the ( [symbol] −1)th scan electrode line with image data ( [symbol] −1, q−1R) corresponding to R cell of the (q−1)th pixel on the ( [symbol] −1)th scan electrode line and outputs logic value 1 if they are the same and logic value 0 if they are different.

The seventh judging unit to ninth judging units (XOR7, XOR8, XOR9) compares each of image data corresponding to R, G, B cells of the qth pixel on the [symbol] th scan electrode line with each of image data corresponding to R, G, B cells of the qth pixel on the ( [symbol] −1)th scan electrode line and judges the change between image data.

That is, the seventh judging unit (XOR7) compares image data ( [symbol] , qR) corresponding to R cell of the qth pixel on the [symbol] th scan electrode line with image data ( [symbol] −1, qR) corresponding to R cell of the qth pixel on the ( [symbol] −1)th scan electrode line and outputs logic value 1 if they are the same and logic value 0 if they are different.

The eighth judging unit (XOR8) compares image data ( [symbol] , qG) corresponding to G cell of the qth pixel on the [symbol] th scan electrode line with image data ( [symbol] −1, qG) corresponding to G cell of the qth pixel on the ( [symbol] −1)th scan electrode line and outputs logic value 1 if they are the same and logic value 0 if they are different.

The ninth judging unit (XOR9) compares image data ( [symbol] , qB) corresponding to B cell of the qth pixel on the [symbol] th scan electrode line with image data ( [symbol] −1, qB) corresponding to B cell of the qth pixel on the ( [symbol] −1)th scan electrode line and outputs logic value 1 if they are the same and logic value 0 if they are different.

The decoder (Dec) outputs 3 bit signals corresponding to the output signals (Value1, Value2, Value3) of each of the first to the third judging units (XOR1, XOR2, XOR3), output signals (Value4, Value5, Value6)of each of the fourth to the sixth judging units (XOR4, XOR5, XOR6), and output signals (Value7, Value8, Value9) of each of the seventh to the ninth judging unit (XOR7, XOR8, XOR9).

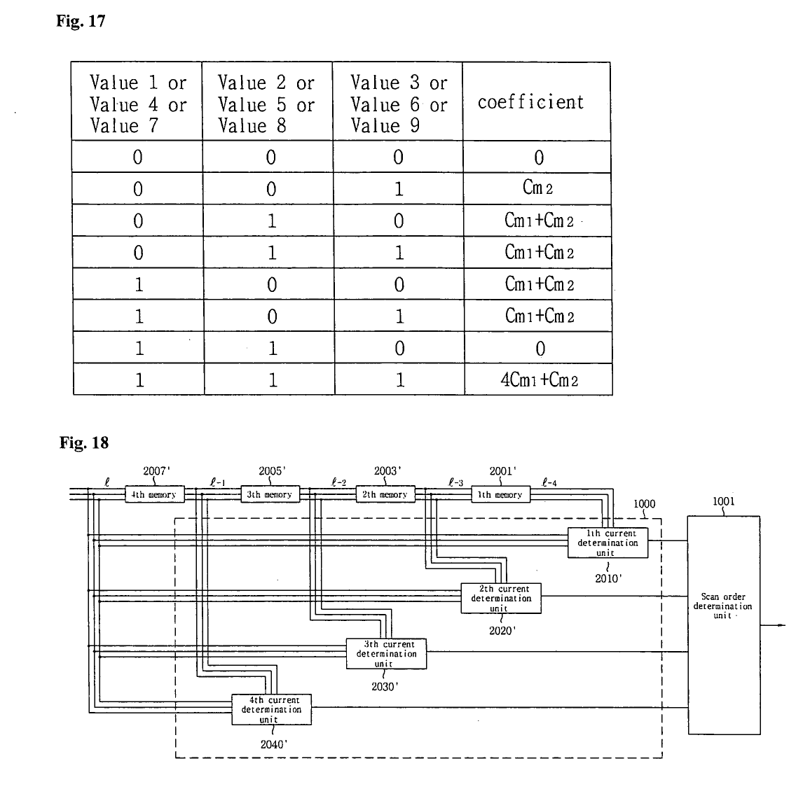

FIG. 17 is a diagram illustrating pattern the contents of image data depending on output signals of the first to the ninth judging units (XOR1 to XOR9) included in the circuit blocks shown in FIG. 16.

Referring to FIG. 17, each of the first adder to third adders (Int1, Int2, Int3) adds (C1, C2, C3) the number of output of 3 bit signals corresponding to output signals (Value1, Value2, Value3) of the first to the third judging units (XOR1, XOR2, XOR3) from the decoder (Dec) and outputs the added result.

Each of the fourth adder to the sixth adder (Int4, Int5, Int6) adds (C4, C5, C6) the number of output of 3 bit signals corresponding to output signals (Value4, Value5, Value6) of the fourth to the sixth judging units (XOR4, XOR5, XOR6) from the decoder (Dec) and outputs the added result.

Each of the seventh adders to ninth adders (Int7, Int8, Int9) adds (C7, C8, C9) the number of output of 3 bit signals corresponding to output signals (Value7, Value8, Value8) of the seventh to the ninth judging units (XOR7, XOR8, XOR9) from the decoder (Dec) and outputs the added result.

Each of the first current calculator to the third current calculator (Cal1, Cal2, Cal3) receives C1, C2 and C3 from the first adder (Int1), the second adder (Int2), and the third adder (Int3) and calculates a magnitude of a displacement current.

Each of the fourth current calculator to sixth current calculators (Cal4, Cal5, Cal6) receives C4, C5 and C6 from the fourth adder (Int4), the fifth adder (Int5), and the sixth adder (Int6) and calculates a magnitude of a displacement current.

Each of the seventh current calculator to the ninth current calculator (Cal7, Cal8, Cal9) receives C7, C8 and C9 from the seventh adder (Int7), the eighth adder (Int8), and the ninth adder (Int9) and calculates a magnitude of a displacement current.

The first current adder (Add1) adds the magnitudes of displacement currents calculated from each of the first to the third current calculators (Cal1, Cal2, Cal3).

The second current adder (Add2) adds the magnitudes of displacement currents calculated from each of the fourth to the sixth current calculators (Cal4, Cal5, Cal6).

The third current adder (Add3) adds the magnitudes of displacement currents calculated from each of the seventh to the ninth current calculators (Cal7, Cal8, Cal9).

A magnitude of a displacement current for the change of image data corresponding to each cell can be calculated.

FIG. 18 is a block diagram of the data comparing unit 1000 and the scan order determining unit 1001 of the scan driver in the plasma display apparatus according to the present invention referring to the FIGS. 16 and 17.

Referring to FIG. 18, the data comparing unit 1000 referring to the FIGS. 16 and 17 has a structure in which four basic circuit blocks, that is, the first current discriminator to fourth current discriminators 910′, 920′, 930′ and 940′ shown in FIG. 18 are connected to each other and the scan order determining unit 1001 determines a scan order generating the smallest displacement current by comparing the output of 4 basic circuit blocks.

The first current discriminator 910′ compares image data ( [symbol] , qR) with image data ( [symbol] , qG), image data ( [symbol] , qG) with image data ( [symbol] , qB), image data ( [symbol] , qB) with image data ( [symbol] , q−4R), image data ( [symbol] −4, qR) with image data ( [symbol] −4, qG), image data ( [symbol] −4, qG) with image data ( [symbol] −4, qB), image data ( [symbol] −4, qB) with ( [symbol] −4, q−1R), image data [symbol] , qR) with image data ( [symbol] −4, qR), image data ( [symbol] , qG) with image data ( [symbol] −4, qG), and image data ( [symbol] , qB) with image data ( [symbol] −4, qB).

Reference numerals [symbol] and [symbol] −4 indicate the [symbol] th scan electrode line and the ( [symbol] −4)th scan electrode line. Reference numerals qR, qG; and qB indicate each of R, G, B cells of the qth pixel. Reference numerals q−1R, q−1C and q−1B indicate each of R, G, B cells of the (q−1)th pixel.

Therefore, the first current discriminator 910′ compares such image data and calculates a magnitude of a displacement current corresponding to a scan order of Type4.

The second current discriminator 920′ compares image data ( [symbol] , qR) with image data ( [symbol] , qG), image data ( [symbol] , qG) with image data ( [symbol] , qB), image data ( [symbol] , qB) with image data ( [symbol] , q−1R), image data ( [symbol] −3, qR) with image data ( [symbol] −3, qG), image data ( [symbol] −3, qG) with image data ( [symbol] −3, qB), image data ( [symbol] −3, qB) with ( [symbol] −3, q−1R), image data ( [symbol] , qR) with image data ( [symbol] −3, qR), image data ( [symbol] , qG) with image data ( [symbol] −3, qG), and image data ( [symbol] , qB) with image data ( [symbol] −3, qB). Reference numerals [symbol] and [symbol] −3 indicate the [symbol] th scan electrode line and the ( [symbol] −3)th scan electrode line.

Therefore, the second current discriminator 920′ compares such image data and calculates a magnitude of a displacement current corresponding to a scan order of Type3.

The third current discriminator 930′ compares image data ( [symbol] , qR) with image data ( [symbol] , qG), image data ( [symbol] , qG) with image data ( [symbol] , qB), image data ( [symbol] , qB) with image data ( [symbol] , q−1R), image data ( [symbol] −2, qR) with image data ( [symbol] −2, qG), image data ( [symbol] −2, qG) with image data ( [symbol] −2, qB), image data ( [symbol] −2, qB) with ( [symbol] −2, q−1R), image data ( [symbol] , qR) with image data ( [symbol] −2, qR), image data ( [symbol] , qG) with image data ( [symbol] −2, qG), and image data ( [symbol] , qB) with image data ( [symbol] −2, qB). At this time, reference numerals [symbol] and [symbol] −2 indicate the

th scan electrode line and the ( [symbol] −2)th scan electrode line.

Therefore, the third current discriminator 930′ compares such image data, and calculates a magnitude of a displacement current corresponding to a scan order of Type2.

The fourth current discriminator 940′ compares image data ( [symbol] , qR) with image data ( [symbol] , qG), image data ( [symbol] , qG) with image data ( [symbol] , qB), image data ( [symbol] , qB) with image data ( [symbol] , q−1R), image data ( [symbol] −1, qR) with image data ( [symbol] −1, qG), image data ( [symbol] −1, qG) with image data ( [symbol] −1, qB), image data ( [symbol] −1, qB) with ( [symbol] −1, q−1R), image data ( [symbol] , qR) with image data ( [symbol] −1, qR), image data ( [symbol] , qG) with image data ( [symbol] −1, qG), and image data ( [symbol] , qB) with image data ( [symbol] −1, qB). At this time, reference numerals [symbol] and [symbol] −1 indicate the [symbol] th scan electrode line and the ( [symbol] −1)th scan electrode line.

Therefore, the fourth current discriminator 940′ compares such image data and calculates a magnitude of a displacement current corresponding to a scan order of Type1.

The scan order determining unit 1001 receives magnitudes of displacement currents in which each of the first to fourth current discriminators 91O′, 930′, 950′, and 970′ calculates and determines a scan order by a current discriminator outputs the lowest displacement current among them.

For example, if it is determined that a magnitude of a displacement current in which the scan order determining unit 1001 receives from the second current discriminator 930′ is the lowest, the scan order determining unit 1001 scans an order of Y1-Y4-Y7- . . . , Y2-Y5-Y8- . . . , Y3-Y6-Y9- . . . as in the third scan type (Type 3) of FIG. 9.

If it is determined that a magnitude of a displacement current in which the scan order determining unit 1001 receives from the second current discriminator 950′ is the lowest, the scan order determining unit 1001 scans an order of Y1-Y3-Y5- . . . , Y2-Y4-Y6- . . . as in the second scan type (Type 2) of FIG. 9.

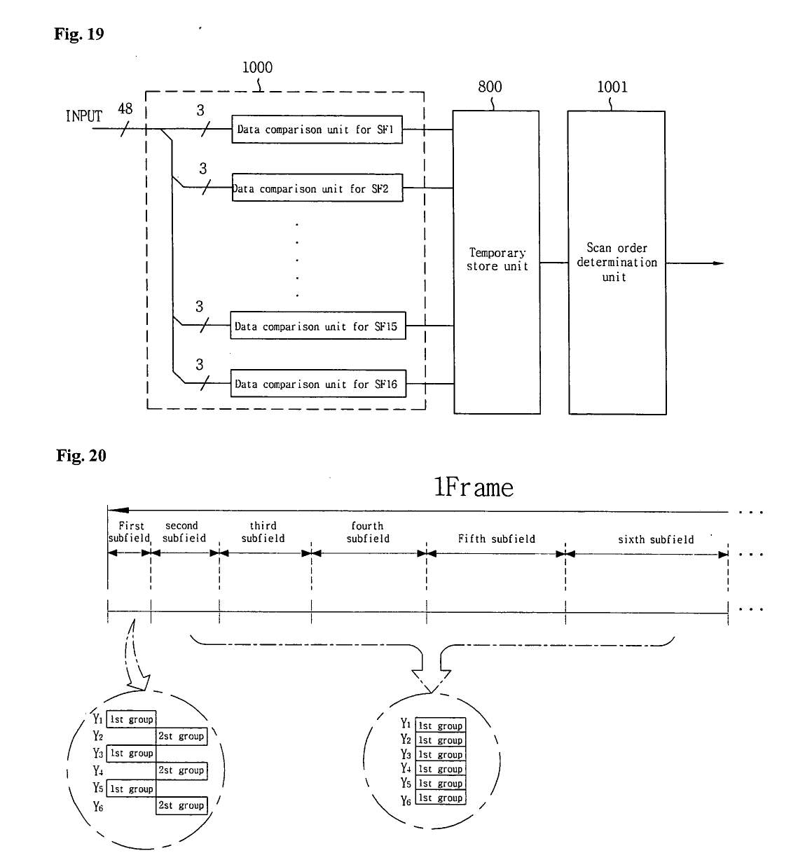

FIG. 19 is a block diagram of an embodiment in which the data comparing unit and the scan order determining unit according to the present invention are applied to each subfield.

Referring to FIG. 19, each of the data comparing unit for the first subfield (SF1) to the data comparing unit for the sixteenth subfield (SF16) calculates a magnitude of a displacement current depending on an image pattern in the corresponding subfield for a plurality of scan types and stores the calculated result to a temporary storage unit 800.

Each of the data comparing units for the first subfield (SF1) to the data comparing unit for the sixteenth subfield (SF16) is identical with a block construction of the data comparing unit shown in FIG. 14, calculates a magnitude of a displacement current depending on pattern of image data in each subfield for a plurality of scan types and stores the calculated result to the temporary storage unit 800.

The scan order determining unit 1001 compares the magnitudes of displacement currents depending on a pattern of image data for each subfield inputted from the temporary storage unit 800, selects the pattern of image data having the lowest displacement current, and determines a scan order in each subfield.

The plasma display apparatus and a driving method thereof according to the present invention calculate a displacement current between the scan electrode lines corresponding to each of a plurality of scan types and sequentially scans the lines corresponding to a scan type in which a magnitude of a displacement current is the lowest.

That is, FIG. 9 shows that a scan type having the lowest displacement current is selected by calculating the displacement currents between the lines which are regularly separated by a fixed number and a scan type having the lowest displacement current can be selected by calculating the displacement current between the lines which are separated irregularly or by any rule. In the above description, the displacement current is calculated by using a weight (Cm2, Cm1+Cm2, or 4Cm1+Cm2) including at least one of the capacitances Cm1 and Cm2, but the displacement current of a subfield can be obtained by allowing a magnitude of a displacement current to be “U0”v when a displacement current does not flow and a magnitude of a displacement current to be “U1”v when a displacement current flows without using a weight and adding up a value of “U0”v or “U1”v. For example, in FIG. 11, the first to third adders (736-1 to 736-3) may be constructed with one adder and the current calculator (737-1 to 737-3) and the current adder (738) may be omitted. In this case, one adder counts the number of output of C1, C2, and C3 and calculates a count value itself as a displacement current.

A subfield which scans the scan electrodes (Y) with any one scan type among a plurality of scan types can be randomly determined within one frame and it is described with reference to the attached FIG. 20.

FIG. 20 is a diagram illustrating an embodiment of a method of selecting a subfield which scans the scan electrodes (Y) with any one scan type among the plurality of scan types within one frame.

Referring to FIG. 20, only in the first subfield having the lowest gray level weight among the subfields included in one frame, scan electrodes (Y) are scanned with the first scan type (Type 1) shown in FIG. 9 and in the remaining subfields, the scan electrodes (Y) are scanned with a general scanning method that is, a sequential scanning method. Specifically, the displacement currents for a plurality of scan types are calculated in one more selected subfield among the subfields of one frame and the scan electrodes (Y) are scanned with a scan type in which the displacement current becomes the lowest in each subfield.

However, it is more preferable that as in FIG. 19, the displacement currents for a plurality of scan types are calculated in each subfield included in one frame and the scan electrodes (Y) are scanned with a scan type in which the displacement current becomes the lowest in each subfield.

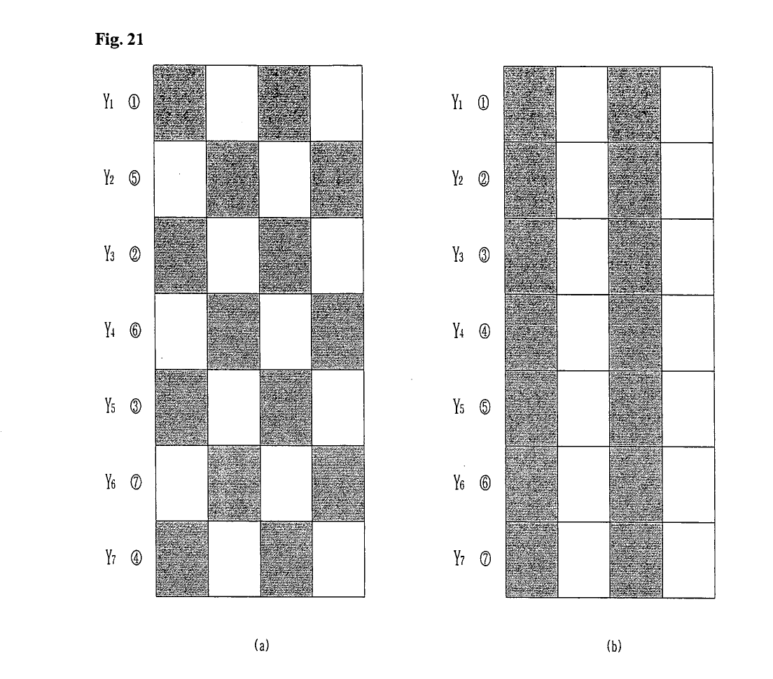

When a pattern of image data comprises the first pattern and the second pattern, a scan order in the first pattern of the image data and a scan order in the second pattern may be different. This will be described with reference to the attached FIG. 21.

FIG. 21 is a diagram illustrating that scan orders may be different in patterns of two different image data.

Referring to FIG. 21, a pattern of image data in which logic level ‘1’ and logic level ‘0’ are alternately arranged in vertical and lateral directions is shown in (a) of FIG. 21 and a pattern of image data in which logic level ‘1’ and logic level ‘0’ are alternately arranged in a lateral direction but logic levels do not change in a vertical direction is shown in (b) of FIG. 21.

In the case of the pattern of image data of (a), scan electrodes (Y) are scanned in a scan order of Y1-Y3-Y5-Y7-Y2-Y4-Y6 and in case of the pattern of image data of (b), scan electrodes (Y) are scanned in a scan order of Y1-Y2-Y3-Y4-Y5-Y6-Y7. That is, as the image data have a pattern of (a) or (b), a scan order of the scan electrodes (Y) becomes different.

The reason that a scan order of scan electrodes (Y) is adjusted is already described in detail, and thus the detailed description will be omitted.

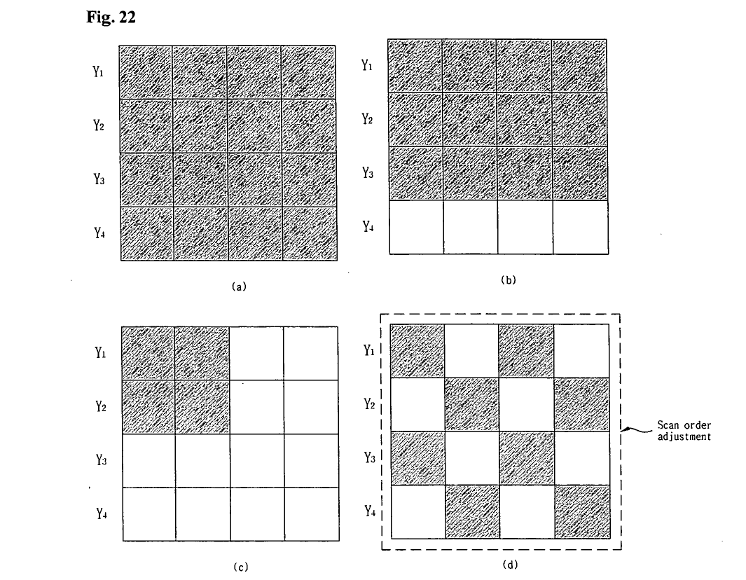

As described above, when a scan order of the scan electrodes (Y) is adjusted in consideration of a pattern of image data, it is preferable that a critical value for a pattern of image data is set and the scan order is adjusted based on the preset critical value. This will be described with reference to FIG. 22.

FIG. 22 is a diagram illustrating an embodiment of a method of adjusting a scan order by setting a critical value depending on a pattern of image data.

Referring to FIG. 22, a case where all of the image data is high level, that is, logic level ‘1’ is shown in (a) of FIG. 22, a case where all of the image data is logic level ‘1’ on Y1, Y2, and Y3 scan electrode lines and logic level ‘0’ on Y4 scan electrode line is shown in (b) of FIG. 22, a case where the image data is logic level ‘1’ at the first and the second of Y1 and Y2 scan electrode lines and logic level ‘0’ at the third and the fourth thereof and all of the image data is logic level ‘1’ on Y3 and Y4 scan electrode lines is shown in (c) of FIG. 22, and a case where logic level ‘1’ and ‘0’ are alternately arranged is shown in (d) of FIG. 22.

Since switching of a data driver integrated circuit is not generated in (a) of FIG. 22, the number of total switching is 0, and total 4 switching of the data driver integrated circuit is generated in a vertical direction in (b) of FIG. 22, total 2 switching is generated in a vertical direction and total 2 switching is generated in a lateral direction in (c) of FIG. 22, and total 12 switching is generated in a vertical direction and total 12 switching is generated in a lateral direction in (d) of FIG. 22. Therefore, in a case of (d) of FIG. 22, a load depending on a pattern is largest.

As already described in detail, it is preferable that a load value depending on a pattern of data is obtained by the sum of a load value of a lateral direction and a load value of a vertical direction of a corresponding data pattern.

If the preset critical load value is a load depending on total 10 switching in a vertical direction and total 10 switching in a lateral direction, only (d) pattern among the above-mentioned (a), (b), (c), and (d) patterns exceeds the preset critical load value.

Exceeding the critical load value means that a magnitude of a displacement current depending on pattern of data is a preset critical current or more.

When image data is supplied, a scan order of the scan electrodes (Y) can be adjusted with (d) pattern. Adjustment of a scan order of the scan electrodes (Y) is already described in detail and thus the descriptions will be omitted.

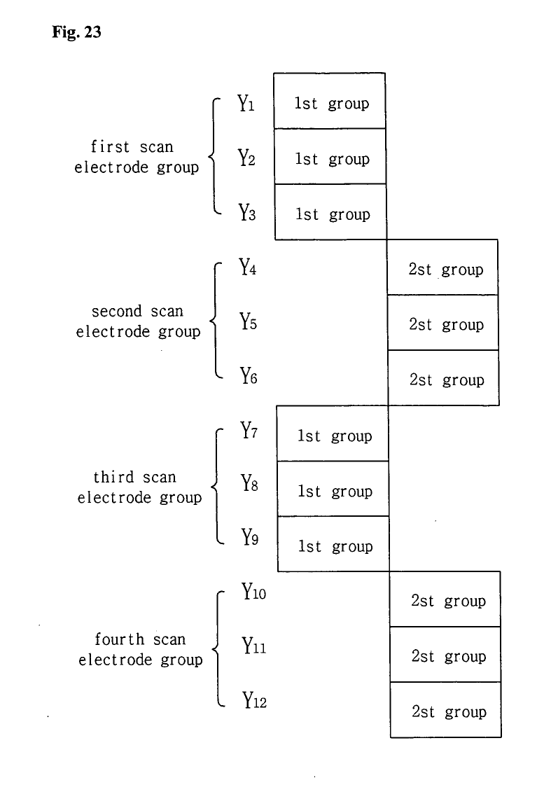

In the above description, a scan type having a scan order corresponding to each scan electrode (Y) is determined and according to the scan type, scanning is performed depending on a scan order corresponding to each scan electrode (Y), but a plurality of scan electrodes (Y) may be set as a scan electrode group and thus a scan order may be determined. It will be described with reference to the attached FIG. 23.

FIG. 23 is a diagram illustrating an embodiment of a method of determining a scan order corresponding to a scan electrode group including a plurality of scan electrodes (Y).

Referring to FIG. 23, Y1, Y2 and Y3 scan electrodes are set as a first scan electrode group, and Y4, Y5 and Y6 scan electrodes are set as a second scan electrode group, and Y7, Y8 and Y9 scan electrodes are set as a third scan electrode group, and Y10, Y11 and Y12 scan electrodes are set as a fourth scan electrode group. In FIG. 23, each scan electrode group is set to include 4 scan electrodes, but each may include, for example, 2, 3 or 5 scan electrodes.

At least one among a plurality of scan electrode groups may include a different scan electrode group and a different number of scan electrodes (Y). For example, 2 scan electrodes (Y) may be included in the first scan electrode group and 4 scan electrodes (Y) may be included in the second scan electrode group.

When scan electrodes are set as a scan electrode group, if the second type (Type 2) shown in FIG. 9 is applied, as in FIG. 23, the third scan electrode group is scanned after the first scan electrode group is scanned, then the second and fourth scan electrode groups are sequentially scanned. In order words, scanning is performed in an order of Y1, Y2, Y3, Y7, Y8, Y9, Y4, Y5, Y6, Y10, Y11 and Y12.

The invention being thus described, may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plurality of scan electrodes;
a plurality of sustain electrodes formed in parallel to the scan electrodes;
data electrodes intersecting the scan electrodes and the sustain electrodes;
a scan driver scanning the scan electrodes with one scan type among a plurality of scan types having different scan orders which scan the plurality of scan electrodes in an address period;
a data driver supplying data to the data electrodes corresponding to the one scan type; and
a sustain driver supplying a first sustain bios voltage that is less than a second sustain bios voltage supplied to the sustain electrodes in the address period from a setdown period of a reset period before the address period to a period before a first scan pulse is supplied to the scan electrodes.

2. The plasma display apparatus of claim 1, wherein the scan driver calculates displacement currents corresponding to each of a plurality of scan types depending on inputted image data and scans the scan electrodes with a scan type having the lowest displacement current among the plurality of scan types.

3. The plasma display apparatus of claim 2, wherein the scan electrode comprises the first and the second scan electrodes separated by a predetermined number depending on the scan type,
the data electrode comprises the first and second data electrodes, and
when the scan driver comprises a first and second discharge cells disposed at intersections of the first scan electrode and the first and second data electrodes and a third and fourth discharge cells disposed at intersections of the second scan electrode and the first and the second data electrodes, the scan driver calculates the displacement current for the first discharge cell by comparing the data of the first to the fourth discharge cells.

4. The plasma display apparatus of claim 3, wherein the scan driver obtains a first result in which data of the first discharge cell and data of the second discharge cell are compared, a second result in which data of the first discharge cell and data of the third discharge cell are compared, and a third result in which data of the third discharge cell and data of the fourth discharge cell are compared, determine a calculating equation of the displacement current depending on a combination of the first to third results, and calculates a total displacement current of the first discharge cell by totaling the displacement currents calculated using the determined calculating equation.

5. The plasma display apparatus of claim 4, wherein if a capacitance between adjacent data electrodes is Cm1, a capacitance between the data electrode and the scan electrode and a capacitance between the data electrode and the sustain electrode are Cm2,
the scan driver calculates the displacement current depending on a combination of the first to third results based on Cm1 and Cm2.

6. The plasma display apparatus of claim 2, wherein the scan driver calculates a displacement current for the plurality of scan types in each subfield of one frame and scans the scan electrode with a scan type in which the displacement current becomes the lowest in each subfield.

7. The plasma display apparatus of claim 2, wherein the scan type comprises a first scan type which divides the scan electrodes into a plurality of group and scans the divided scan electrodes,
when a scan type in which the displacement current becomes the lowest is the first scan type, the scan driver continuously scans the scan electrodes belonging to the same group in the first scan type.

8. The plasma display apparatus of claim 1, wherein the scan driver calculates a displacement current corresponding to each of the plurality of scan types depending on inputted image data and scans the scan electrodes with at least one scan type among scan types in which the displacement current is a preset critical displacement current or less among the plurality of scan types.

9. The plasma display apparatus of claim 1, wherein the first sustain bias voltage is a ground level voltage (GND).

10. The plasma display apparatus of claim 1, wherein the second sustain bias voltage is less than or equal to the sustain voltage (Vs) supplied to the scan electrode or the sustain electrode in a sustain period after the address period.

11. The plasma display apparatus of claim 1, wherein the sustain driver supplies the first sustain bias voltage to the sustain electrode during a setdown period of the reset period.

12. The plasma display apparatus of claim 1, wherein the sustain driver supplies a first sustain bios voltage that is less than a second sustain bios voltage supplied to the sustain electrodes in the address period of a predetermined subfield among subfields of one frame from a setdown period of the reset period before the address period to a period before a first scan pulse is supplied to the scan electrodes.

13. The plasma display apparatus of claim 1, wherein the sustain driver supplies a rising waveform in which a voltage gradually rises from the first sustain bias voltage to the second sustain bias voltage to the sustain electrode after the first sustain bias voltage is supplied.

14. The plasma display apparatus of claim 13, wherein a rising slope of a voltage of the rising waveform from the first sustain bias voltage to the second sustain bias voltage is smoother than a rising slope of a rising voltage of sustain pulses supplied to the scan electrodes or the sustain electrodes in a sustain period after the address period.

15. A plasma display apparatus comprising:
a plasma display panel in which a plurality of scan electrodes and sustain electrodes, and data electrodes intersecting the scan electrodes and the sustain electrodes are formed;
a scan driver scanning the scan electrodes by allowing a scan order of the plurality of scan electrodes to be different from the scan order of the first data pattern in a second data pattern different from a first data pattern among data patterns of inputted image data;
a data driver supplying a data pulse to the data electrodes corresponding to the scan order of the plurality of scan electrodes; and
a sustain driver supplying a first sustain bios voltage that is less than a second sustain bios voltage supplied to the sustain electrodes in an address period from a setdown period of a reset period before the address period to a period before a first scan pulse is supplied to the scan electrodes.

16. The plasma display apparatus of claim 15, wherein a first data pattern or a second data pattern allows a load value depending on pattern of data to be a preset critical load value or more.

17. The plasma display apparatus of claim 16, wherein a load value depending on pattern of data is obtained by the sum of a load value of a horizontal direction and that of a vertical direction of a corresponding data pattern.

18. The plasma display apparatus of claim 15, wherein the first data pattern or the second data pattern allows a magnitude of a displacement current depending on pattern of data to be a preset critical current value or more.

19. A method of driving a plasma display apparatus comprising scan electrodes, sustain electrodes, and data electrodes formed in a direction intersecting the scan electrodes and the sustain electrodes, the method comprising:
scanning the scan electrodes in one scan type among a plurality of scan types scanning the plurality of scan electrodes in different scan orders in an address period;
supplying data to the data electrodes corresponding to the one scan type; and
supplying a first sustain bios voltage that is less than a second sustain bios voltage supplied to the sustain electrodes in the address period from a setdown period of a reset period before the address period to a period before a first scan pulse is supplied to the scan electrodes.

20. A method of driving a plasma display apparatus comprising a plurality of scan electrodes and sustain electrodes, and data electrodes formed in a direction intersecting the scan electrodes and the sustain electrodes, the method comprising:
scanning the scan electrodes by allowing a scan order of the plurality of scan electrodes to be different from the scan order of the first data pattern in a second data pattern different from a first data pattern among data patterns of inputted image data;
supplying data pulses to the data electrodes corresponding to the scan order of the plurality of scan electrodes; and
supplying a first sustain bios voltage that is less than a second sustain bios voltage supplied to the sustain electrodes in an address period from a setdown period of a reset period before the address period to a period before a first scan pulse is supplied to the scan electrodes.
